(19) United States
(12) Patent Application Publication
(10) Pub. No.: US 2008/0100564 A1
(43) Pub. Date: May 1, 2008

(54) Color display with polarization-type molecular switch

(76) Inventors: Kent D. Vincent, Cupertino, CA (US); Sean Xiao-An Zhang, Cupertino, CA (US); Zhang-Lin Zhou, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/588,967

(22) Filed: Oct. 26, 2006

(51) Int. Cl. G09G 3/34

(52) U.S. Cl. 345/107

(57) ABSTRACT

An electronically addressable display comprises a substrate, at least one polarization-type, electrical field switchable molecular colorant associated with the substrate, and an addressing device mounted for selectively switching the at least one molecular colorant between at least two visually distinguishable states. Electronic devices including the electronically addressable displays and methods of manufacturing the electronically addressable display are also disclosed.

### FIELD OF THE INVENTION

The present invention relates generally to electronic document distribution and, more particularly, to a reusable, high resolution display whose functional length scales are measured in nanometers, which include polarization-type molecules that provide optical switching.

### BACKGROUND OF THE INVENTION

The area of electronic document distribution has experienced growing interest in recent years. The advent of the Internet has provided contemporaneous information access to documentary information while avoiding the high cost of printing, binding, warehousing, distribution, retail mark-up that is associated with commercial print documents. (The term Internet is used herein as a generic term for a collection of distributed, interconnected networks (ARPANET, DARPANET, World Wide Web, or the like) that are linked together by a set of industry standard protocols (e.g., TCP/IP, HTTP, UDP, and the like) to form a generally global, distributed network. Private and proprietary intranets are also known and are amenable to conforming uses of the present invention.) Additionally, the typical user often reads such hard copy only once and then discards or stores the same for future reference.

However, currently working against the advantages of electronic document distribution, computer displayed documents suffer from significantly poor quality relative to hard copy print and are harder to read. For example, standard cathode ray tube (CRT) and matrix liquid crystal displays (LCD) operate at resolutions approximately an order of magnitude lower than commercial print. As a result, the document image is usually magnified on display for better viewability, which is turn, allows only a fraction of a standard document page to be viewed at one time. Small character and image detail such as serifs and thin lines are lost, while larger character and image details are aliased or made fuzzy by grey-scaling the original data. Moreover, CRT displays are not portable and require the user to read documents at essentially fixed focal length and fixed body position for long periods of time, leading to eye and body discomfort. Flat panel, matrix LCD devices are lighter weight and more portable for easier focal distance and body repositioning, but are of poorer contrast and limited available viewing angle, leading to further reading discomfort and annoyance. Viewability of such displays also is affected by the ambient lighting in which the apparatus is being used; the higher the ambient light conditions, the worse the viewability of the displayed image or information. In addition to the aforementioned shortcomings of electronic displays, such displays are relatively high in power consumption, particularly if the screen is of the active transistor type.

Use of electrostatically polarized, bichromal particles for displays has been known since the early 1960's. The need for an electronic paper-like print means has recently prompted development of at least two electrochromic picture element (pixel) colorants: (1) a microencapsulated electrophoretic colorant (electronic ink), and (2) a field rotatable bichromal colorant sphere (e.g., the Xerox® Gyricon™). Each of these electrochromic colorants is approximately hemispherically bichromal, where one hemisphere of each microcapsule is made the display background color (e.g., white) while the second hemisphere is made the print or image color (e.g., black or dark blue).

Electronic ink, manufactured by E Ink Corporation (Cambridge, Mass.), is provided in a liquid form that can be coated onto a surface. Within the coating are tiny microcapsules (e.g., about 30 μm to 100 μm in diameter, viz. about as thick as a human hair, thus quite visible to the naked eye). Each microcapsule has oppositely charged white and black pigment particles suspended in a dielectric liquid. When an electric field is applied and sustained in a first polarity, the white particles move to one end of the microcapsule where they become visible while the black particles are drawn to the non-visible side of the microcapsule; this makes the surface appear white at that spot. A carrier is provided. An opposite polarity electric field pulls the black particles to the visible end of the microcapsules and the white particles to the non-visible side of the microcapsule; this makes the surface appear black at that spot.

The Xerox Gyricon sphere includes a bichromal sphere having colored hemispheres of differing Zeta potential that allow the spheres to rotate in a dielectric fluid under influence of an addressable electrical field. Essentially, each sphere has a bichromal ball having two hemispheres, typically one black and one white, each having different electrical properties. Each ball is enclosed within a spherical shell and a space between the ball and shell is filled with a liquid to form a microsphere so that the ball is free to rotate in response to an electrical field. The microspheres can be mixed into a substrate which can be formed into sheets or can be applied to a surface. The result is a film which can form an image from an applied and sustained electrical field. Currently, picture element (“pixel”) resolution using this Gyricon spheres is limited to about 100 dpi.

Thus, in the aforementioned approaches, each individual colorant device is roughly hemispherically bichromal; one hemisphere is made the display background color (e.g. white) while the second hemisphere is made the print or image color (e.g. black or dark blue). In accordance with the text and image data, these microsphere-based colorant devices are field translated or rotated so the desired hemisphere color faces the observer at each respective pixel. It can be noted that, in commercial practice, displays made from these colorants have relatively poor contrast and color.

Another approach, referred to as a liquid powder display, incorporates oppositely charged black and white pigments each in an array of cells, with each cell defining a pixel. Electrodes on the opposing faces of each cell are used to create electric fields within the cell that draw the colored pigments either to the observed front surface or to an unseen back surface of the cell, making the cell appear either black or white, accordingly, depending on field direction. Yet another approach, referred to as an electro-wetting display, includes a similar array of pixel cells with opposing cell electrodes. Each cell contains a dye solution that either wets (thus coloring the observed cell wall) or contracts into a substantially unseen droplet in the presence or absence of an applied electric field. A degrading issue with each of these “cell” technologies, including the E-Ink capsule, is visibility of the cell wall and its effect on image contrast. The cell wall needs a minimum thickness for structure and manufacturing purposes. As the resolution of the display is increased and more pixels per inch are added, the observed area of the passive wall becomes a predominantly greater percentage of the pixel. To date, this deficiency has limited display resolution to less than desired levels.

To overcome some of these problems, use of molecular switches has been explored. One molecular switch that has been studied includes a rotaxane molecule and a catenane molecule. The rotaxane molecule includes an “axle” having a long, straight molecule and one or more rings. The rings are threaded onto the axle and bulky groups are bonded onto the end of the axle. This structure has been described as preventing the rings from sliding off without having any chemical bonds between the ring and the axle. The catenane molecule includes two interlocking rings. In one molecular switch, the catenane molecule is trapped between two metal electrodes and is switched from an ON state to an OFF state by the application of a positive bias across the molecule. The ON and OFF states differ in resistivity by about a factor of 100 and 5, respectively, for the rotaxane molecule and catenane molecule.

The rotaxane-based switch is typically an irreversible switch. It can only be toggled once. In addition, for rotaxane, an oxidation or reduction reaction occurs before the switch can be toggled. Thus, the reaction to toggle the switch requires an expenditure of a significant amount of energy. In addition, the large and complex nature of rotaxanes and related compounds potentially make the switching times of the molecules slow. The catenane-based switches have displayed small ON-to-OFF ratios and have also displayed slow switching times. Although reversibility in rotaxane-based switches has been shown in some solvent systems, no switching has been demonstrated in solid systems, such as those desired for displays. This limitation in a solid matrix is believed to be due to the ring being sterically hindered by the matrix from moving the necessary distances for reliable switching.

Thus, there remains a need for cost-efficient, erasable and reusable, high contrast, high resolution displays, which permit reasonably rapid switching from a first state to a second, are reversible to permit real-time or video rate display applications, and can be used in a variety of optical devices.

### BRIEF SUMMARY OF THE INVENTION

An electronically addressable display comprises a substrate, at least one polarization-type, electrical field switchable molecular colorant associated with the substrate, and an addressing device mounted for selectively switching the at least one molecular colorant between at least two visually distinguishable states. Electronic devices including the electronically addressable displays and methods of manufacturing the electronically addressable display are also disclosed.

### BRIEF DESCRIPTION OF THE SEVERAL VIEWS OF THE DRAWINGS

FIG. 1 is a schematic representation (perspective, transparent view) of a two color (e.g., black and white) display screen construction for use in accordance with the present invention;

FIG. 1a is a detail for a colorant layer element of the display screen depicted in FIG. 1;

FIG. 2 is a schematic representation (perspective, transparent view) of a full-color display screen construction for use in accordance with the present invention;

FIG. 3 is a schematic representation of a scan addressing embodiment of a two-color display screen construction for use in accordance with the present invention;

FIGS. 4 and 5 are schematic illustrations of embodiments of the present invention showing two exemplary strategies for implementation;

FIGS. 6A-6C illustrate a schematic view of one embodiment of e-field polarization with or without tautomerization of a molecule;

FIGS. 7A-7C illustrate a schematic view of another embodiment of e-field polarization with or without tautomerization of the molecule;

FIGS. 8A-8D illustrate a schematic view of another embodiment of an e-field induced molecular polarization with molecular tautomerization;

FIGS. 9A and 9B illustrate a schematic view of an e-field induced molecular polarization with molecular tautomerization for an additional molecule embodiment;

FIGS. 10A and 10B illustrate a schematic view of one embodiment of an e-field induced molecular polarization and molecular tautomerization;

FIGS. 11A and 11B illustrate a schematic view of an e-field induced molecular polarization with molecular tautomerization for two molecule embodiments;

FIGS. 12A and 12B illustrate a schematic view of an e-field induced molecular polarization with molecular tautomerization for two additional molecule embodiments;

FIGS. 13A and 13B illustrate a schematic view of an e-field induced molecular polarization with molecular tautomerization for two additional molecule embodiments;

FIGS. 14A-14C illustrate schematic representations of alternate molecule embodiments;

FIG. 15 illustrates a schematic representation of an alternative molecule embodiment;

FIGS. 16-25 illustrate a schematic view of e-field induced molecular polarizations and molecular tautomerization in various molecular embodiments; and

FIG. 26 a specific example of an e-filed induced property change of a representative OHDTS molecule.

### DETAILED DESCRIPTION OF THE INVENTION

The term “self-assembled” as used herein refers to a system that naturally adopts some geometric pattern because of the identity of the components of the system; the system achieves at least a local minimum in its energy by adopting this configuration.

The term “singly configurable” means that a switch can change its state only once via an irreversible process such as an oxidation or reduction reaction; such a switch can be the basis of a programmable read-only memory (PROM), for example.

The term “reconfigurable” means that a switch can change its state multiple times via a reversible process such as an oxidation or reduction; in other words, the switch can be opened and closed multiple times, such as the memory bits in a random access memory (RAM) or a color pixel in a display.

The term “bi-stable” as applied to a molecule means a molecule having two relatively low energy states (local minima) separated by an energy (or activation) barrier. The molecule may be either irreversibly switched from one state to the other (singly configurable) or reversibly switched from one state to the other (reconfigurable). The term “multi-stable” refers to a molecule with more than two such low energy states, or local minima.

Micron-scale dimensions refer to dimensions that range from 1 micrometer to a few micrometers in size. Sub-micron scale dimensions refer to dimensions that range from 1 micrometer down to 0.05 micrometers. Nanometer scale dimensions refer to dimensions that range from 0.1 nanometers to 50 nanometers (0.05 micrometers).

Micron-scale and submicron-scale wires refers to rod or ribbon-shaped conductors or semiconductors with widths or diameters having the dimensions of 0.05 to 10 micrometers, heights that can range from a few tens of nanometers to a micrometer, and lengths of several micrometers and longer.

“HOMO” is the common chemical acronym for “highest occupied molecular orbital”, while ““LUMO” is the common chemical acronym for “lowest unoccupied molecular orbital”. HOMOs and LUMOs are responsible for electronic conduction in molecules and the energy difference between the HOMO and LUMO and other energetically nearby molecular orbitals is responsible for the color of the molecule.

A molecular or optical switch, in the context of the present invention, involves changes in the electromagnetic properties of the molecules, both within and outside that detectable by the human eye, e.g., ranging from the far infra-red (IR) to deep ultraviolet (UV). Molecular or optical switching includes changes in properties such as absorption, reflection, refraction, diffraction, and diffuse scattering of electromagnetic radiation.

The term “transparency” is defined within the visible spectrum to mean that optically, light passing through the colorant is not impeded or altered except in the region in which the colorant spectrally absorbs. For example, if the molecular colorant does not absorb in the visible spectrum, then the colorant will appear to have water clear transparency.

The term “omni-ambient illumination viewability” is defined herein as the viewability under any ambient illumination condition to which the eye is responsive.

FIG. 1 illustrates a particular embodiment of the present invention, wherein a display screen 100 is shown that incorporates at least one colorant layer 101. The colorant layer 101 comprises a pixel array using polarization-type, electrical field switchable molecular colorants of the present invention, described in greater detail below and generically referred to as a “molecular colorant”, “molecular switch”, or “colorant”. Each dye or pigment molecule is field switchable either between an image color (e.g., black) and transparent, or between two different colors (e.g., red and green).

Referring briefly to FIG. 1a, the colorant layer 101 is an addressable pixel array formed of bi-stable molecules arrayed such that a selected set of molecules correlates to one pixel. The colorant layer 101 is a thin layer coated on a background substrate 103 having the display's intended background color (e.g., white). The substrate 103 may comprise, for example, a high dielectric pigment (e.g., titania) in a polymer binder that provides good white color and opacity while also minimizing the voltage drop across the layer. The stratified combination of colorant layer 101 and substrate 103 thus is fully analogous to a layer of ink on paper. In a blank mode, or erased state, each molecule is switched to its transparent orientation, i.e., the “layer of ink” is invisible. The background (e.g., white pixels) shows through in those pixel areas where the colorant layer 101 molecules are switched to the transparent orientation. A transparent view-through layer 105, such as of a clear plastic or glass, is provided superjacent to the colorant-background sandwich to provide appropriate protection. The view-through layer 105 has a transparent electrode array 107 for pixel column or row activation mounted thereto and positioned superjacently to the colorant layer 101. The background substrate 103 has a complementary electrode array 109 for pixel row or column activation mounted thereto (a skilled artisan will recognize that a specific implementation of the stratification of the electrode arrays 107, 109 for matrix addressing and field writing of the individual pixels may vary in accordance with conventional electrical engineering practices). Optionally, the pixels can be sandwiched by employing thin film transistor (TFT) driver technology as would be known in the art. Molecular bi-stability is not required when TFT drivers are used.

The present display 100 is capable of the same contrast, brightness, and color as hard copy print. A molecular colorant is ideal because its size and mass are infinitesimally small, allowing resolution and colorant switching times that are limited only by the field writing electrodes and circuitry. Like ink, the colorant layer 101 may develop adequate density in a sub-micron to micron thin layer, potentially lowering the field voltage required to switch the colorant between logic states and thus allowing the use of inexpensive drive circuitry.

Suitable reconfigurable bi-stable molecules for use in such displays are disclosed below and claimed herein. These molecules have optical properties (e.g., color) that are determined by the extent of their polarization state and electron conjugation. The optical properties, including color or transparency, of the molecule change with field polarity applied across the molecule and can remain chromatically stable in the absence of an applied electric field. By disrupting the continuity of conjugation across a molecule, the molecule may be changed from one optical state to another, e.g., colored to transparent. Electric dipoles may be designed into the colorant that can physically cause this disruption by rotating or otherwise distorting certain segments of the dye or pigment molecule relative to other segments, when an external electric field is applied or changed.

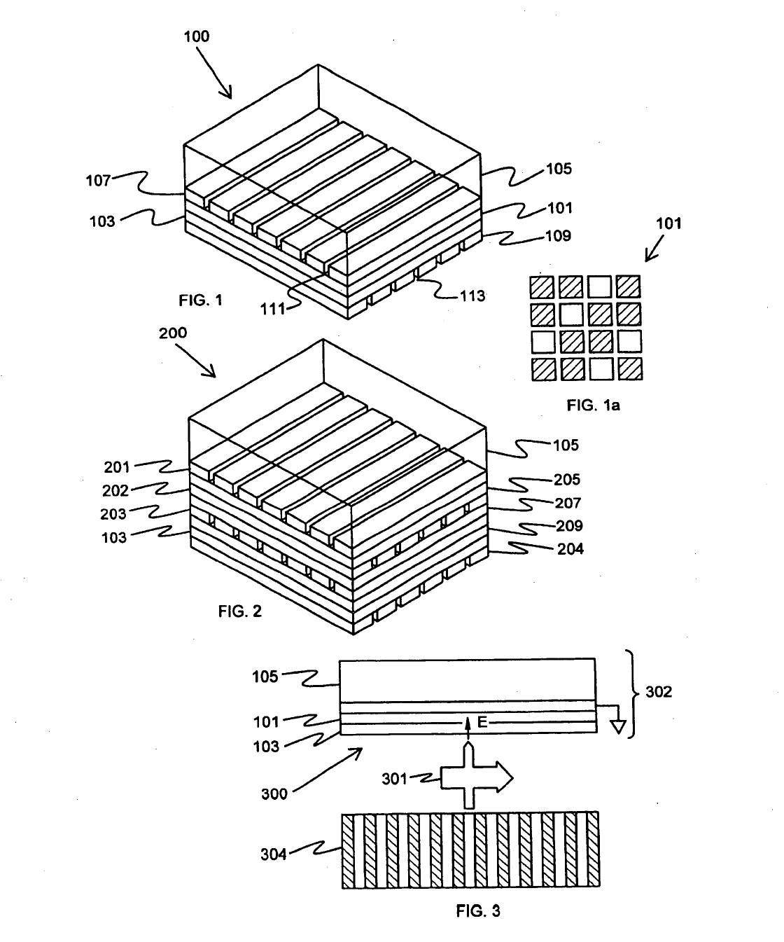

The colorant layer 101 can be formed as a homogeneous layer of molecules, which are preferably colored (e.g., black, cyan, magenta, or yellow) in a more-conjugated orientation and transparent in a less-conjugated orientation. For example, by making the abutting background substrate 103 white, the colorant layer 101 may thereby produce high contrast black and white, and colored images. The colorant layer 101 may comprise a single field switchable dye or pigment or may comprise a mixture of different switchable dyes or pigments that collectively produce a composite color (e.g., black). By using a molecular colorant, the resolution of the produced image is limited only by the electric field resolution produced by the electrode array 107, 109. The molecular colorant additionally has virtually instantaneous switching speed, beneficial to the needs of fast scanning (as described with respect to FIG. 3 hereinafter). In certain cases, the molecular colorant may be contained in a polymeric layer. Polymers for producing such coatings are well-known, and include, for example, acrylates, urethanes, and the like. Alternatively, the colorant layer 101 may be self-assembled.

In one embodiment, the colorant layer 101 can be offered as a substitute for matrix-addressed liquid crystal flat panel displays. As is well-known for such displays, each pixel is addressed through rows and columns of fixed-position electrode arrays (e.g., 107 and 109). The fixed-position electrode arrays 107, 109 consist of conventional crossbar electrodes 111, 113 that sandwich the colorant layer 101 to form an overlapping grid (matrix) of pixels, each pixel being addressed at the point of electrode overlap. The crossbar electrodes 111, 113 comprise parallel, spaced electrode lines arranged in electrode rows and columns, where the row and column electrodes are separated on opposing sides of the colorant layer 101. Preferably, a first set of transparent crossbar electrodes 107 (201, 203 in FIG. 2 described in detail hereinafter) is formed by thin film deposition of indium tin oxide (ITO) on a transparent substrate (e.g., glass). These row addressable pixel crossbar electrodes 107 can be formed in the ITO layer using conventional thin film patterning and etching techniques. The colorant layer 101 and background substrate 103 can be sequentially coated over or mounted to the transparent electrode layer, using conventional thin film techniques (e.g., vapor deposition) or thick film techniques (e.g., silkscreen, spin cast, or the like). Additional coating techniques include Langmuir-Blodgett deposition and self-assembled monolayers. Column addressable pixel crossbar electrodes 109 (202, 204 in FIG. 2) can be constructed in like manner to the row electrodes 107. The column addressable pixel crossbar electrodes 109 may optionally be constructed on a separate substrate that is subsequently adhered to the white coating using conventional techniques.

This display 100, 200 provides print-on-paper-like contrast, brightness, color, viewing angle, and omni-ambient illumination viewability by eliminating the polarization layers required for known liquid crystal colorants. Using the described-display also allows a significant reduction in power drain. Whereas liquid crystals require a holding field even for a static image, the present molecules of the colorant layer 101 can be modal in the absence of a field when bi-stable molecules are used. Thus, the present bi-stable colorant layer 101 only requires a field when a pixel is changed and only for that pixel. The power and image quality improvements will provide significant benefit in battery life and display readability, under a wider range of viewing and illumination conditions for display devices (e.g., wristwatches, calculators, cell phones, or other mobile electronic applications) television monitors and computer displays. Furthermore, the colorant layer may comprise a mosaic of colored pixels using an array of bi-stable color molecules of various colors for lower resolution color displays.

In an alternative embodiment, a charge storage capacitor can be used to provide bi-stability to a colorant molecule that is not inherently bi-stable. As with a charge storage capacitor, the colorant acts as a capacitor dielectric that is polarized by the externally applied electric field in a way that opposes the external field. The two fields are self-stabilizing such that the colorant molecule remains polarized even when the external field voltage is switched off. The polarized state remains until the charge on the electrodes is drained off or until the externally applied field is reversed. Thus, inherent bi-stability in the colorant molecule is not required in order to maintain the bi-stable function through the charge storage effect. Passive matrix addressing using the charge storage effect is robust because the colorant has a definite switch energy. Parasitic fields coupling less than this energy do not switch the colorant. Therefore, molecule bi-stability can include both inherent bi-stability and charge storage effect bi-stability.

Since each colorant molecule in colorant layer 101 is transparent outside of the colorant absorption band, then multiple colorant layers may be superimposed and separately addressed to produce higher resolution color displays. FIG. 2 is a schematic illustration of one such particular embodiment. A high resolution, full color, matrix addressable, display screen 200 comprises alternating layers of transparent electrodes—row electrodes 201, 203 and column electrodes 202 and 204—and a plurality of colorant layers 205, 207, 209, each having a different color molecule array. Since each pixel in each colorant layer may be colored or transparent, the color of a given pixel may be made from any one or a combination of the color layers (e.g., cyan, magenta, yellow, black) at the full address resolution of the display. When all colorant layers 205, 207, 209 for a pixel are made transparent, then the pixel shows the background substrate 103 (e.g., white). Such a display offers the benefit of three or more times resolution over present matrix LCD devices having the same pixel density but that rely on single layer mosaic color. Moreover, the multilayer display provides greater display brightness than a single layer mosaic display since all light not used to produce a particular color is reflected back. Light passing through adjacent mosaic color pixels (e.g. cyan and magenta) are typically absorbed to produce a single color pixel (e.g. yellow). Details of the fabrication of the display are well known by persons of skill in the art.

The color to be set for each pixel is addressed by applying a voltage across the electrodes directly adjacent to the selected color layer. For example, assuming yellow is the uppermost colorant layer, 205 magenta is the next colorant layer 207, and cyan is the third colorant layer 209, then pixels in the yellow layer are addressed through row electrodes 201 and column electrodes 202, magenta through column electrodes 202 and row electrodes 203, and cyan through row electrodes 203 and column electrodes 204. This common electrode addressing scheme is made possible because each colorant molecule can be made to be color stable in the absence of an applied electric field.

FIG. 3 depicts another embodiment of the invention, which employs scan-addressing rather than matrix-addressing. Matrix address displays are presently limited in resolution by the number of address lines and spaces that may be patterned over the relatively large two-dimensional surface of a display, each line connecting pixel row or column to the outer edge of the display area. In this representative embodiment, the bi-stable molecular colorant layer 101 and background substrate 103 layer construction is combined with a scanning electrode array printhead to provide a scanning electrode display apparatus 300 having the same readability benefits as the first two embodiments described above, with the addition of commercial publishing resolution. Scanning electrode arrays and drive electronics are common to electrostatic printers and their constructions and interfaces are well-known. Basically, remembering that the bi-stable molecular switch does not require a holding field, the scanning electrode array display apparatus 300 changes a displayed image by printing a pixel row at a time. The scanning electrode array display apparatus 300 thus provides far greater resolution by virtue of the ability to alternate odd and even electrode address lines along opposing sides of the array, to include multiple address layers with pass-through array connections and to stagger multiple arrays that proportionately superimpose during a scan. The colorant layer 101 may again be patterned with a color mosaic to produce an exceptionally high resolution scanning color display.

More specifically, the embodiment shown in FIG. 3 comprises a display screen 302, a scanned electrode array 304, and array translation mechanism 301 to accurately move the electrode array across the surface of the screen. The display screen 302 again comprises a background substrate 103, a transparent view through layer 105, and at least one bi-stable molecule colorant layer 101. The colorant layer 101 may include a homogeneous monochrome colorant (e.g., black) or color mosaic, as described herein above. The scanned electrode array 304 comprises a linear array or equivalent staggered array of electrodes in contact or near contact with the background substrate 103. A staggered array of electrodes may be used, for example, to minimize field crosstalk between otherwise adjacent electrodes and to increase display resolution.

In operation, each electrode is sized, positioned, and electrically addressed to provide an appropriate electric field, represented by the arrow labeled ““E”, across the colorant layer 101 at a given pixel location along a pixel column. The field E may be oriented perpendicular to the plane of the colorant layer 101 or parallel to it, depending on the color switching axis of the colorant molecules. A perpendicular field may be produced by placing a common electrode (e.g., an ITO layer) on the opposing coating side to the electrode array. The electrode array may also be constructed to emit fringe fields; a parallel fringe field may be produced by placing a common electrode adjacent and parallel to the array. A perpendicular fringe field may be produced by placing symmetrically spaced parallel common electrodes about the electrode array(s). The voltage is adjusted so that the dominant field line formed directly beneath the array 304 is sufficiently strong to switch the addressed colorant molecule(s) and divided return lines are not.

The present invention contemplates a wide variety of substrate materials and forms. For example, the colorant layer may be affixed onto a plastic or other flexible, durable, material substrate in the approximate size, thickness, and shape of any available printable media. The particular substrate composition implemented is fully dependent on the specific application and, particularly, to the role that the substrate plays in supporting or creating the electric field that is imposed across the colorant layer. In fact, the molecular coating, at least in a bi-stable molecular system form, can be used with any surface upon which writing or images can be formed. While this provides an exemplary implementation, it should be noted that a variety of flat panel and projection display systems using appropriate substrate materials (e.g., for computer and television screens) can also be implemented.

In another embodiment, the present concept allows a single field switchable molecular colorant molecule, for example, between black and transparent, or white and transparent, to provide color switching for multiple display pixel colors (e.g., the primary additive colors—red, blue, green—or the primary subtractive colors—cyan, magenta, yellow—and black). Black and white switchable molecular colorants either absorb or scatter, respectively, virtually all incident visible light in a first switch state and transmit virtually all incident light in a second switch state where the molecule is transparent. In other words, the molecule for this embodiment does not need to further provide a specific spectral absorption profile characteristic of any specific color. A matrix of single field switchable molecular black/transparent or white/transparent molecules can act as a light valve in a coating layer that is situated to be optically adjacent to a color mosaic filter or color mosaic print of non-switchable colors. The color mosaic is a repetitious pattern of pixels wherein each pixel has, for example, a cyan, magenta, yellow, and black subpixel element. Alternatively, a color display may be constructed of a light valve matrix of black/transparent or white/transparent molecules sequentially illuminated by different colored illuminants (e.g., red, green and blue light emitting diodes (LEDs)). In this embodiment, a single sequence or multiple full-color sequences can be completed within the span of a single video frame. The light valve for each pixel can be modulated as appropriate for each color illumination to produce the desired composite pixel color as integrated by the persistence function of the observing eye.

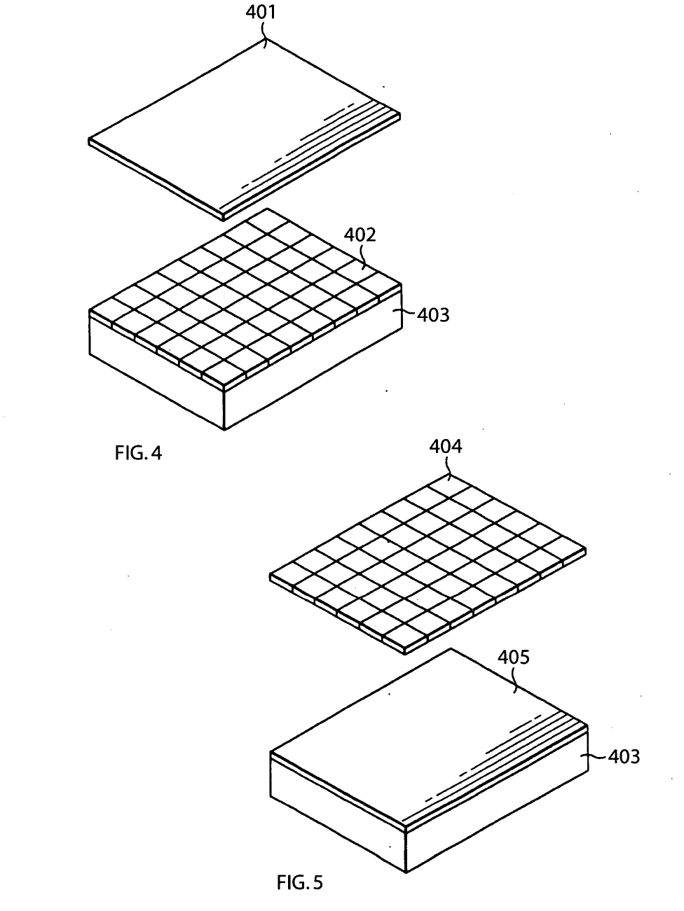

FIGS. 4 and 5 illustrate another embodiment where two adjacent imaging layers 401, 402 or 404, 405, respectively, are provided on a substrate 403. In FIG. 4, the molecules of valve layer 401 are selectively switchable between black and transparent states. In FIG. 5, the molecules of valve layer 405 are selectively switchable between white and transparent states.

A mosaic color imaging layer 402, 404 includes, but is not limited to, a regular pattern of color pixels at a predetermined resolution (e.g., 1200 pixels per inch (““ppi”)), in other words, a resolution greater than that for average human visual dot discrimination ability. A mosaic color imaging layer 402 that is printed on, or otherwise mounted on, substrate 403 to be subjacent the molecular valve layer 401 may be a mosaic pattern formed by a printed mosaic color pattern, thus acting as background for the black-transparent molecular valving layer 401, as shown in FIG. 4. The mosaic pattern may be formed conventionally such as by printing with pigment, dye, or combined pigment and dye. Thus, no color shows through with the molecular light valves in the black switch state and color shows through in the transparent switch state.

The use of conventional mosaic filters as shown in FIG. 5 is in accordance with the known manner, conventional technology for single sensor video cameras, flat panel displays, and the like. Likewise the use of a conventional color filter (e.g., as used in color LCD screens) for backlit or projection displaying of an image can be implemented, with the back-transparent colorant molecules able to serve as a light valve similar to liquid crystal shutters. The benefit of each of these approaches is that it uses a single molecular colorant with conventional mosaic colorant (ink, filters). The color mosaic filter may optionally be printed as a background layer on a protective, transparent substrate (e.g., glass). These approaches allow full color without inherent color, switched molecules (e.g., yellow/transparent state, and the like).

In operation, the molecular valve layer 401, 405 is selectively switched in a pixel-wise fashion from a black or white state to a transparent state via applied electric fields. The color of any given pixel on the image layer 402, 404 is optically transmitted in those pixel areas where the valve layer 401, 405 is made transparent. The adjacent color is elsewhere blocked by the black state of the molecular light valves. Where the default-switch state for the embodiment of FIG. 4 is black, the display will present a CRT appearance; in other words, the display will appear black except where color pixels are otherwise reflecting light. For the embodiment of FIG. 5, the default switch state is white, so that the display will present an appearance of a sheet of white paper; in other words, the displayed image will appear white except where color pixels are otherwise visible through those molecular valves in the transparent state.

In still another implementation, where a background light source is provided as part of the substrate 403 to make a emitted light projection display, the molecular valve layer 401, 405 can be made to use black-transparent switchable molecules, in order to cut off the rear-projected light from pixels that are not to be illuminated.

This molecular light valve embodiment can also take advantage of the use of bistable molecules whereby the electric field can be turned off after image forming, conserving device energy.

Notably, because the colorant molecules can be implemented in an embodiment having a transparent state, colorant strata can be layered (e.g., molecules switching between transparent and primary colors in separate strata layers) such that very high resolution, full color rendering can be accomplished through multi-color layer pixel superposition (e.g., overlays of the subtractive primary colors cyan, magenta and yellow), while maintaining fully rewritable formats.

In accordance with the present invention, molecules evidencing polarization-type molecular color switching are provided for the colorant layers 101, 205, 207, 209, 401, and 405. The color switching is the result of an E-field induced intramolecular polarization change, rather than a diffusion reaction, molecular folding/stretching, or oxidation/reduction reaction, in contrast to prior art approaches. Also, the part of the molecule that moves is quite small, so the switching time is expected to be quite fast. Also, the molecules are much simpler and thus easier and cheaper to make than the rotaxanes, catenanes, and related compounds.

The following are examples of model molecules with a brief description of their function:

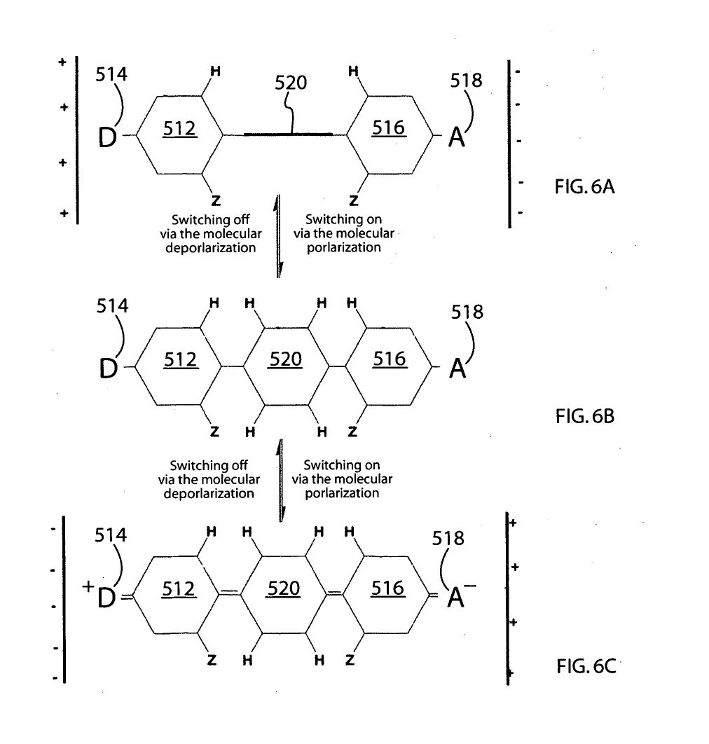

An electric field or electromagnetic field molecular switch described herein, illustrated for one embodiment, schematically in FIGS. 6A, 6B and 6C, includes an aromatic donor subunit 512 with donor 514, an aromatic acceptor subunit 516 with acceptor 518, and an aromatic bridging subunit 520, bridging the aromatic donor subunit 512 and aromatic acceptor subunit 516. The aromatic donor subunit 512 includes one or more aromatic ring systems with at least one electron donating group in the ring system or attached directly to the ring system of the aromatic donor subunit 512. The aromatic acceptor subunit 516 includes one or more aromatic ring systems with at least one electron accepting group in the ring system or attached directly to the ring system of the aromatic acceptor-subunit 516.

The molecular switch is referred to herein as a D-B-A molecule, which is a donor-bridge-acceptor molecule. The donor 514 and aromatic donor subgroup 512 “push” electrons along the D-B-A molecule. The acceptor 18 and aromatic acceptor subunit 516 “pull” electrons along the D-B-A molecule. The aromatic bridging subunit 520 bridges and modulates the “pushing” and “pulling” of electrons by the donor 514 and the acceptor 518. This action is referred to as the “push-bridge-pull” action of the D-B-A molecule.

The molecular switch is schematically shown with the aromatic bridging subunit 520 out of the plane of the D-B-A molecule in FIG. 6A. With this conformation, the D-B-A molecule has a very large electronic band-gap and smaller dipole movement. The D-B-A molecule has little or no charge transfers between the donor 514 and acceptor 518 ends due to a cut off of the conjugated push-bridge-pull action.

Switching off the extended conjugation between donor subunit 512 and the aromatic acceptor subunit 516 via molecular depolarization results in the aromatic bridging subunit 520 “flipping” out of the plane of the D-B-A molecule as is shown in FIG. 6A. Switching on the extended conjugation between donor subunit 512 and the aromatic acceptor subunit 516 via molecular polarization results in the aromatic bridging subunit 520 “flipping” into the plane of the D-B-A molecule as is shown in FIG. 6B. When the conformation of the D-B-A molecule shown in FIG. 6B is subjected to a further polarization and charge separation, a fully polarized conformation is achieved, as is shown in FIG. 6C. The D-B-A molecular conformation shown in FIG. 6C displays larger dipole and smaller band-gap than the conformation shown in FIG. 6B which is caused by a charge transfer between the donor and acceptor ends. The result is molecular polarization and a complete conjugated push-bridge-pull action.

For the D-B-A molecule embodiments described herein, none of the rotating elements have dipoles. The dipole falls along the axis of the rotating elements of the D-B-A molecule embodiments and, effectively, over the length of the entire molecule.

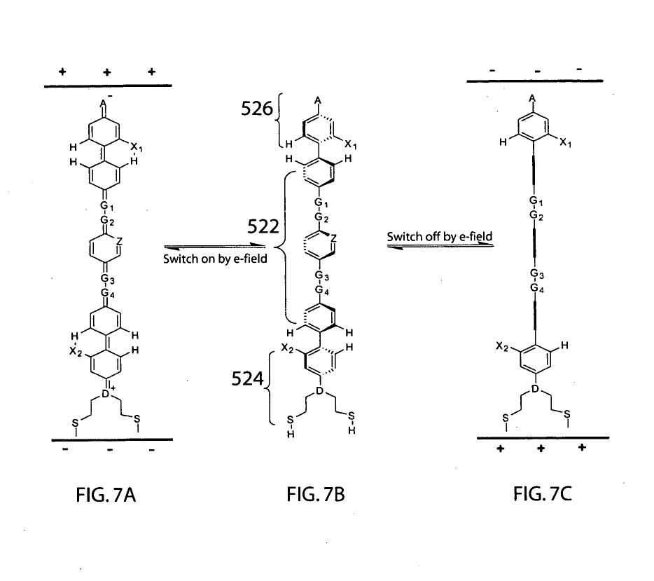

A specific embodiment of the aromatic bridging subunit, illustrated in FIG. 7B, can include bridging groups G1, G2, G3, G4, hindrance groups X1 and X2, and, for some embodiments, one or more auxochromic groups. The group, X2, bonded to the bridging subunit, has use as both a hindrance group and, for some embodiments, has a tuning functionality. FIG. 7A illustrates the D-B-A molecule embodiment in an “ON” state, wherein the molecule is polarized. FIG. 7B illustrates the D-B-A molecule embodiment in a transition state and FIG. 7C illustrates the D-B-A molecule in an “OFF” state, wherein the molecule is depolarized.

The aromatic bridging subunit 520 of the D-B-A molecule, by rotating, acts as a rotor and the aromatic acceptor subunit 518 and aromatic donor subunit 512 act as stators of the molecular switch. When an electric field of low voltage is applied to the D-B-A molecule, the vector dipole moment of the rotor 520 aligns parallel to the direction of the electric field. When switched to a specific orientation, the D-B-A molecule remains in the orientation until it is switched to a different orientation or reconfigured. Some embodiments of the D-B-A molecule include hindrance groups such as X1 and X2, illustrated in FIGS. 7A, 7B and 7C that prevent the rotor 520 from rotating through a 180 degree half cycle.

For the embodiment shown in FIGS. 7A, 7B and 7C, an aromatic bridging subunit 522 is a conjugated system including one or more switchable bi-ring systems. For this embodiment, the aromatic rings are connected directly to aromatic rings of both donor 524 and acceptor 526 units by sigma bonds, thereby forming two sets of bi-phenyl types of adjacent aromatic ring systems, herein referred to as BPA systems. One of the BPA systems is illustrated in FIGS. 7A, 7B and 7C at 522, and is designated as the “middle bridging unit.” Another embodiment is illustrated as follows:

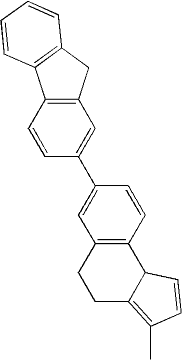

These BPA systems are presented as examples only and are not intended to limit the subject matter described herein. The BPA type of system includes two adjacent aromatic rings, which are switchable “ON” and “OFF”, respectively, to connect or disconnect the donor subunit and acceptor subunit, respectively, by an external e-field, or electromagnetic field or optical field. Either of the two adjacent aromatic rings of the BPA system may be a single hydrocarbon or heterocyclic aromatic rings such as benzene, thiophene, pyrrole, furan, oxadazole, thiazole, pyrimidine, pyridine and so forth, or a poly-aromatic system with or without a heteroatom such as fluorene, pyrene, anthracene, and indole.

In another embodiment, the middle bridging subunit, such as is shown at 520 in FIG. 6A is an isolated conjugated system, which is different from each of the donor and acceptor subunits. In one other embodiment, the bridging subunit is a part of a conjugation system of either the donor or the acceptor subunits.

In another embodiment, the middle bridging subunit is a conjugated system with twisted aromatic rings at each of two ends, which are connected directly or indirectly to aromatic ring systems of each of the donor and the acceptor, respectively, or both through the sigma bond. With this embodiment, the middle-bridging segment is characterized as a twisted conjugated system that is switchable “ON” or “OFF” using an external electric field to electrically connect or disconnect a donor and acceptor from each other.

The aromatic bridging subunit 522 also includes G1-G2 and G3-G4 bridging groups, shown in FIGS. 7A, 7B and 7C. The bridging groups are the same for some molecule embodiments and are different for other molecule embodiments. Bridging groups include a single atom such as S, N, O, P, or atomic group such as ethenyl, ethynyl, azo, imine, —N═CH—, —NH—CO— or —N═C(OH)—, —N═C(NH2)—, —N═C(SH)—, —N—CS—, NH—O— and —NHNH—. Other bridging groups are usable in embodiments of the D-B-A molecule.

The hindrance groups X1 and X2, shown in FIG. 7A, 7B and 7C, impart a bi-stability, through use of weak bonds, in one embodiment, hydrogen bonds, between adjacent benzene rings. The hindrance groups are for some embodiments, functional units and for other embodiments, different atoms or atomic groups. The hindrance groups include one or more of hydrogen, hetero-atom, F, Cl, Br, I or functional groups that include some hetero atoms, N, O, S, P, or substituted hydrocarbons. The hindrance groups employ hydrogen bonding or other weak bonding between adjacent benzene rings, such as Coulomb or dipole interactions as well as steric repulsions, or a permanent external e-field to stabilize both charges in a particular orientation. Multiple hindrance groups may contain the same kind of atom or atomic group or different atoms or atomic groups.

Some embodiments of the aromatic bridging subunit include an auxochromic element which includes a chromophore, such as an atomic group. The auxochromic element acts to tune its electronic or optic property of the molecule. The chromophore may include a >CH+ group, —N, —S—, —O—, C═O, or —P═. The auxochromic groups impart an appropriate functional effect in order to tune the band gap of the molecule in order to obtain desired electronic or optic properties. The functional effects include inductive effects and steric effects. The steric effect tunes the molecular conformation through steric hindrance, inter- or intra-molecular interaction forces such as hydrogen bonding, Coulomb interaction and van der Waals or to provide bi- or multiple-stability of molecular interactions.

Also shown in FIGS. 7A, 7B and 7C are particular embodiments of the aromatic acceptor subunit 524 and the aromatic donor subunit 526. The acceptor subunit is connected to the bridging subunit 522 by a bridging group, G1 and G2. The donor subunit is also connected to the bridging subunit by a bridging group, G3 and G4.

Representative D-B-A molecules include the following structure:

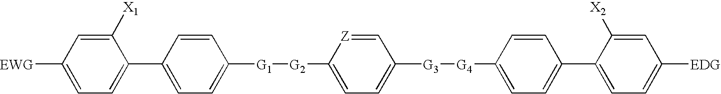

wherein “EWG” is the electron withdrawing group (or acceptor) and is selected from a group consisting of —C(═O)H, —C(═O)R₃, —C(═O)OR₃, —C(═O)OH, —CN, —N═O, —NO₂, —SO₂OH, —N═N—, CH═NR₃, —CR₃═NR₄, —C═C(CN)₂, —C═C(COR₃)₂, —C═C(CO₂R₃)₂, —C═C(COR₃)CO₂R₄, —SO₂OR₃, —S(═O)—R₃, —SO₂R₃, —BH₂, —BHR₃, —BR₃R₄, —PO₃H₂, —PO₃R₃R₄, wherein R₃ and R₄ are substituents independently selected from linear alkyl, branched alkyl, cyclic alkyl, and an aromatic ring system, and wherein the alkyl substituents are substituted or unsubstituted. “EDG” is the electron donating group (or donor) and is selected from a group consisting of —O—, —OH, —OR₁, —NH—, —NH₂, —NHR₁, —NR₁R₂, —PR₁R₂, —PHR₁, —S—, —SH, —SR₁, F, Cl, Br, and 1, wherein R₁ and R₂ are substituents independently selected from linear alkyl, branched alkyl, cyclic alkyl, and an aromatic ring system, and wherein the alkyl substituents are substituted or unsubstituted. X₁ and X₂ are independently selected from a group consisting of hydrogen, F, Cl, Br, and I, —OH, —SH, —NH₂; and substituted alkyl groups. G₁-G₂ and G₃-G₄ are independently selected from a group consisting of —CH═CH—, —CH═CR₅—, —CR₅═CR₆—, —CH₂C(═O)—, —CR₅HC(═O)—, —CC—, —N═N—, —N═CH—, —NH—CO—, —N═C(NH₂)—, —N═C(SH)—, —NCS—, —NH—O— and —NHNH—, wherein R₅ and R₆ are substituents independently selected from linear alkyl, branched alkyl, cyclic alkyl, and an aromatic ring system, and wherein the alkyl substituents are substituted or unsubstituted. Z is selected from a group of atomic units consisting of —CH═, —N═, and —P═.

Other D-B-A molecules include the following structure:

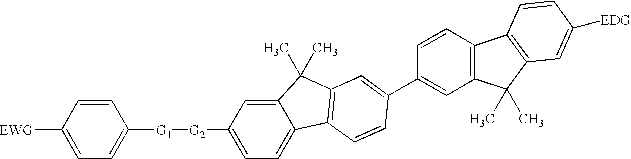

wherein “EWG” is the electron withdrawing group (or acceptor) and is selected from a group consisting of —C(═O)H, —C(═O)R₃, —C(═O)OR₃, —C(═O)OH, —CN, —N═O, —NO₂, —N═N—, CH═NR₃, —CR₃═NR₄, —C═C(CN)₂, —C═C(COR₃)₂, —C═C(CO₂R₃)₂, —C═C(COR₃)CO₂R₄, —SO₂OH, —SO₂OR₃, —S(═O)—R₃, —SO₂R₃, —BH₂, —BHR₃, —BR₃R₄, —PO₃H₂, —PO₃R₃R₄, wherein R₃ and R₄ are substituents independently selected from linear alkyl, branched alkyl, cyclic alkyl, and an aromatic ring system, and wherein the alkyl substituents are substituted or unsubstituted. “EDG” is the electron donating group (or donor) and is selected from a group consisting of —O—, —OH, —OR₁, —NH—, —NH₂, —NHR₁, —NR₁R₂, —PHR₁, —PR₁R₂, —S—, —SH, —SR₁, F, Cl, Br, and I, wherein R₁ and R₂ are substituents independently selected from linear alkyl, branched alkyl, cyclic alkyl, and an aromatic ring system, and wherein the alkyl substituents are substituted or unsubstituted. G₁-G₂ is selected from a group consisting of —CH═CH—, —CH═CR₅—, —CR₅═CR₆—, —CH₂C(═O)—, —CR₅HC(═O)—, —CC—, —N═N—, —N═CH—, —NH—CO—, —N═C(NH₂)—, —N═C(SH)—, —NCS—, —NH—O— and —NHNH—, wherein R₅ and R₆ are substituents independently selected from linear alkyl, branched alkyl, cyclic alkyl, and an aromatic ring system, and wherein the alkyl substituents are substituted or unsubstituted.

Embodiments of the D-B-A molecule of the invention described herein are capable of polarization and de-polarization in e-fields or electromagnetic fields or optical fields having small voltages. The D-B-A molecule embodiments of the invention have energy levels for polarization and de-polarization that are dispersed over the bridging subunit, and at the bridging groups, rather than being concentrated on a single aromatic ring or aromatic group of the bridging subunit. As a result, the bridging groups of the bridging subunit tautomerize or change their charges to “push and pull” the bridging subunit into planar and co-planar positions relative to the donor subunit and acceptor subunit. Because of this energy dispersion, the D-B-A molecule embodiments are polarized and de-polarized in e-fields and electromagnetic fields of low voltage.

Additionally, embodiments of the D-B-A molecule of the invention described herein have attributes of simple self-assembly and have a simple bi-stability mechanism. The D-B-A molecule embodiments display a detectable color change and, for some embodiments, one color state is transparent.

For one embodiment, the D-B-A molecule is switched “OFF” via molecular de-polarization in an e-field. In the “OFF” state, the D-B-A molecule has a large electronic band gap and small dipole moment. The D-B-A molecule has little or no charge transfer between the donor 514 and the acceptor 518 due to a cut off of the conjugated push-bridge-pull action of the D-B-A molecule as shown in FIGS. 6A, 6B and 6C. Also, in the “OFF” state, the aromatic bridging subunit 522 rotates out of the plane of the acceptor and donor subunits of the D-B-A molecule, as is illustrated schematically in FIGS. 7A, 7B and 7C. For some D-B-A molecule embodiments, the molecule has a transparent color when depolarized. For other embodiments, the color of the depolarized molecule is non-transparent.

When the D-B-A molecule is switched “ON,” the aromatic bridging subunit 520 conformation is in the same plane as the aromatic donor and acceptor subunits, as shown in FIGS. 6A, 6B and 6C. In the “ON” state, the D-B-A molecule has a larger dipole and smaller band gap than when in the OFF state. The larger dipole and smaller gap are caused by charge transfers between the donor 514 and acceptor 518, over the bridging subunit 520, as well as molecular polarization. In the “ON” state, the D-B-A molecule displays a complete conjugated “push-bridge-pull” system. In the “ON” state, charge transfer from the donor to acceptor occurs. For some embodiments, the color or the D-B-A molecule changes from transparent to blue.

Orbitals of the D-B-A molecule delocalize throughout the entire D-B-A molecule and are localized within subunits or fragments when the molecule is polarized. This delocalization reduces the voltage of an e-field used to polarize or de-polarize the D-B-A molecule embodiments.

The polarization and de-polarization of the D-B-A molecule embodiments occur when an electric field or an electromagnetic field, hereinafter, an e-field, induces rotation of the aromatic bridging subunit 520. As is shown in FIG. 6A, when the D-B-A molecule is in the “OFF”, depolarized position, the aromatic bridging subunit 520 is oriented out of the plane of the donor subunit and the acceptor subunit.

The HOMO/LUMO band gap change of the D-B-A molecule occurs as a result of mechanical differences between the aromatic bridging subunit 520, which acts as a rotor, and donor groups 512 and 514 acting as stators, and polymerization molecules. The conformation change resulting from rotor stator change and polymerization change occurs when the D-B-A molecule changes from a polarized to a de-polarized state. The D-B-A molecule has dipoles that become larger or smaller, based upon the polarization of the D-B-A molecule. The dipoles increase when the D-B-A molecule is polarized and decrease when the D-B-A molecule is de-polarized. Some embodiments of the D-B-A molecule are divided into at least two or more isolated, highly localized fragments.

When the D-B-A molecule is in an “OFF” state, there is little or no charge transfer between donor and acceptor subunits. When the D-B-A molecule is in the “OFF” state, optical absorption of the molecule is blue shifted.

When the D-B-A molecule changes from a depolarized to polarized state, the D-B-A molecule displays a smaller band gap caused by charge transfer and a highly delocalized state. For some embodiments, the D-B-A molecule displays optical absorption to a red-shifting state when changing to a polarized state.

Charge transfer of some embodiments of the D-B-A molecule are e-field dependent, bi-stable, and are stabilized through inter- or intra-molecular forces such as hydrogen bonding, charge attraction, coulomb forces and so forth. Charge transfer for some embodiments, occurs without π-bonding breakage or formation. For other embodiments, charge transfer occurs with π-bonding breakage or formation. For some embodiments, charge transfers involve some molecular structural tautomerization. For other embodiments, charge transfer does not involve structural tautomerization.

During charge transferring or de-transferring over the D-B-A molecule, activated by an e-field, the band gap of the D-B-A molecule changes depending upon the degree of the p and π electron and de-localization in the molecule. Both optical and electrical properties of embodiments of the D-B-A molecule are changed accordingly.

When the D-B-A molecule is in the “OFF” state, the p and π-conjugation path of the molecule is broken by the bridging subunit, in which the plane of its aromatic system is no longer aligned with the rest of the molecule. The lack of alignment is within an angle range of 10 and 170 degrees, and for some embodiments, between 30 to 150 degrees.

The D-B-A molecules enable production of highly organized three-dimensional molecular assemblies on a solid substrate or on an electrode with a preselected molecular orientation and thickness. The molecular orientation and thickness are preselected by selecting elements of the aromatic bridging subunit 520.

The D-B-A molecule is neither oxidized nor reduced while switched from an “ON” to an “OFF” state or from an “OFF” to an “ON” state. This feature produces a stability that avoids breaking of chemical bonds and potentially initiating a nonreversible reaction. Also, the physical change of the D-B-A molecule as it polarizes or de-polarizes is small. As a consequence, the switching time is fast. In addition, the D-B-A molecules are fabricated using syntheses methods such as those known to those skilled in the art.

For some embodiments, the D-B-A molecule embodiments are symmetrical. For other embodiments, the D-B-A molecule embodiments are asymmetrical.

At least one subunit of D-B-A molecule embodiments has p and π-electrons that are mobilizable over the entire D-B-A molecule or a portion of the molecule. The inducible dipole or dipoles of the D-B-A molecule may be oriented in at least one direction.

The electron acceptor subunit 518 of the D-B-A molecule is an electron-withdrawing subunit. The electron acceptor subunit may include but is not limited to one of the following functional groups: carboxylic acid or derivatives of carboxylic acid, such as an ester group, amide, and other carboxylic acid derivatives; sulfuric acid or derivatives of sulfuric acid; phosphoric acid or derivatives of phosphoric acid; nitro, nitrile, hetero atoms such as N,O, S, P, F, Cl, Br; functional groups with at least one of the hetero atoms such as OH, SH, and NH, hydrocarbons and substituted hydrocarbons, such as CF3, CCl3, —CH═C(CN)COOR, —CH═C(COR)COOR′, and other substituted hydrocarbons.

The electron donor subunit is an electron donating subunit. The electron donor subunit 514 may include one of the following groups: hydrogen, amine, OH, SH, ether, hydrocarbon, either saturated or unsaturated, or substituted hydrocarbon or functional group with at least one of the hetero-atom such as B, Si, I, N, O, S, and P. The donor subunit is differentiated from the acceptor subunit by being less electronegative, or more electropositive than the acceptor subunit.

Both donor and acceptor subunits include one or more aromatic ring systems with at least one electron donating or electron-accepting atom, or atomic group, in the ring or attached to the ring. For some embodiments, the middle-bridging segment is a conjugated system with twisted aromatic rings at each of two ends of the middle-bridging segment. For this embodiment, the aromatic rings of the middle-bridging segment are connected through a tautomerizable unit, to the donor subunit and acceptor subunit.

When this D-B-A molecule embodiment is in a non-polarized state, the two adjacent aromatic ring systems, BPA systems, tend to remain in a twisted conformation instead of a co-planar conformation because of repulsive forces between hydrogen atoms on the two adjacent rings. Electronic communication between donor and acceptor units is cut off, resulting in no charge transfer, for some embodiments, or little charge transfer between donor and acceptor groups due to the non-planar conformation. In this state, the D-B-A molecule embodiment functions as an insulator and its optical absorption is in a region of short wavelength. This state is determined by comparing with the molecule's polarized state.

When an external e-field with a pre-selected orientation is applied to this embodiment of the D-B-A molecule, the molecule polarizes to align with the direction of the external e-field. In order to reach its maximum polarization, that is, to reach the molecule's maximum p-π delocalization state, the ring system of the middle segment is coplanar with the ring systems of the donor and acceptor. Direct charge transfers between the donor and acceptor and a huge dipole are produced by this process. The p-π electrons of all segments of the D-B-A molecule delocalize throughout the entire system, and form a highly conductive state with a much smaller band gap. The optical absorption of the molecule is red shifted.

The D-B-A molecule polarizes and forms a dipole. A localized e-field is generated from the dipole. When an oppositely directed external e-field is applied to the D-B-A molecule, electrostatic repulsion between the external e-field and the localized e-field from the polarized molecular dipole forces the D-B-A molecule to rearrange conformationally in order to minimize charge repulsion, and to minimize the potential energy build-up due to the incompatibility between the localized e-field and external e-field.

Adjacent aromatic rings within the segments of some embodiments of the D-B-A molecule start to twist in certain angles, and form a non-polar conformation. Structural tautomerization of the molecule occurs as well with some of the tautomerizable molecules during the process. Both rings twisting and structural tautomerization of the molecule at this point tends to minimize the polarization of the molecule and reduce or eliminate the charge transfer between the donor and acceptor ends. The electronic communication between donor and acceptor units is once again cut off, and there is little or no charge transfer between donor and acceptor units. The p- and π-electrons of the molecule are localized within each fragment, instead of delocalized throughout the entire molecular system. The optical absorption of the molecule thereby blue shifts. The molecule is stable in this highly insulating state.

The bridging subunit is connected to the donor subunit and acceptor subunit, for some embodiments, either directly or indirectly, by one or more of the bridging groups. For some embodiments, the bridging group may be a single atom such as S, N, O, P and so forth or atomic group such as ethenyl, ethynyl, azo, imine, —N═CH—, —NH—CO— or —N═C(OH)—, —N═C(NH)2-, —N═C(SH)—, —N—CS—, NH—O— and —NHNH—.

For other embodiments, the middle bridging subunit is connected to either the donor subunit or the acceptor subunit or both through a tautomerizable bridging group. Suitable tautomerizable bridging groups include ketones, amides, imines, imides, and so forth and a tautomerization such as [—CH2-CO—/—CH═C(OH)—] and/or [—NH—CO—/—N═C(OH)—] type of tautomerization that can be performed under the influence of an external e-field.

This molecule in FIGS. 9A and 9B is unidirectional and anisotropic. The molecule polarizes or de-polarizes with the influence of external field with a huge change in computed molecular dipole (from 12.7 Debyes to 44 Debyes) as well as the computed molecular band gap (from 3.69 eV to 1.83 eV). Both optical and electrical properties of the materials will change accordingly.

The switching of this D-B-A molecule is found reversible and bistable with multilayer stabilization. Tests indicate that considerable Stock Shift and molecular band gap change was observed during the photo-polarization of this molecule.

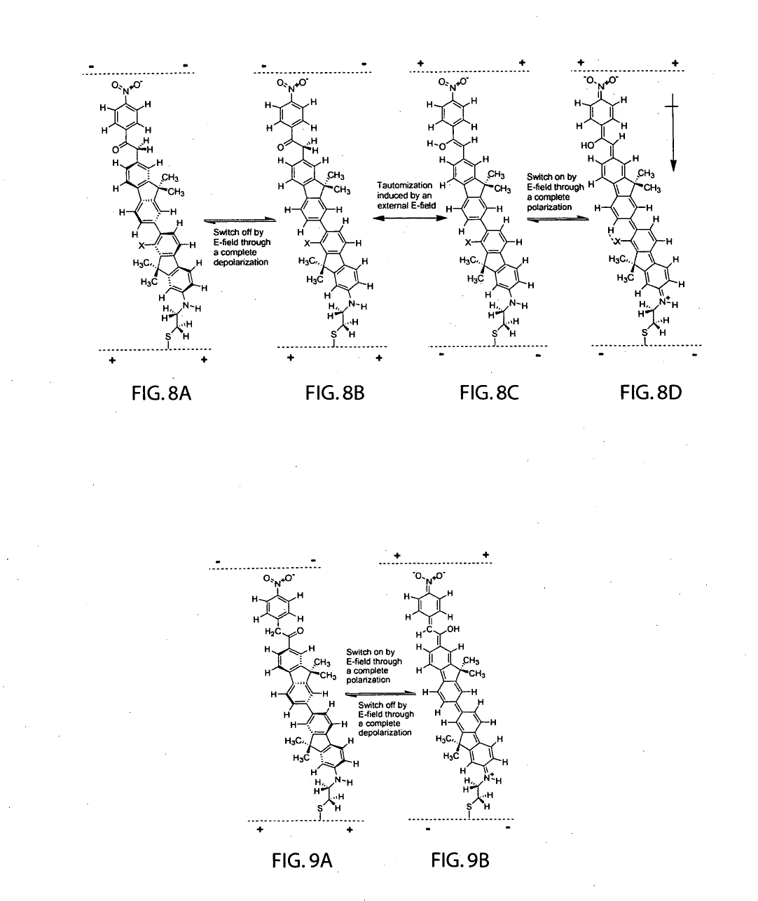

Another embodiment of the D-B-A molecule of the invention described herein is illustrated in FIGS. 8A, 8B, 8C, and 8D. The D-B-A molecule embodiment, illustrated as Molecule 1 in FIG. 8A is shown in a computed non-polarized or partially polarized state of ΔE_{HUMO/LUMO}=3.33 eV and μ=6.78 Debyes. The non-polarized Molecule 1 is switched “OFF” through a complete depolarization, which transitioned the D-B-A molecule to a ketone form transition state, illustrated in FIG. 8B. The ketone form, which is also a transition state, of the D-B-A molecule is tautomerized by application of an external e-field to form an enol form transition state, shown in FIG. 8C. The enol form transition state is switched on by an e-field through a complete polarization to form a fully polarized state, in FIG. 8D. In this fully polarized state in FIG. 8D, E (HOMO/LUMO)=1.26 eV and μ=41.9 Debyes.

The D-B-A molecule shown in FIGS. 8A-8D is constructed with an electron-donating group, HS—CH₂CH₂NH—, an electron-accepting group (PhNO₂) along with a bridging subunit. The bridging subunit is a direct link of two fluorene groups. The electron-donating group, HS—CH₂CH₂NH—, is attached directly to one end of the bi-fluorene segment, and the electron accepting group, -PhNO₂, is linked with another end of the bi-fluorene segment with a tautomerizable ketone —(CH₂CO—) group. The bi-fluorene segment has features similar to those of bi-phenyl types of adjacent aromatic systems, BPA.

When the molecule 1 is in a non-polarized state, the tautomerizable group of the D-B-A molecule tend to remain in ketone form (—CH₂CO—) and the bi-fluorene rings of the bridging subunits tend to remain in a twisted conformation, approximately 31 degree angle between the two fluorene rings, because of the repulsive forces between hydrogen atoms on the two adjacent aromatic rings of the BPA system. The electronic communication between donor and acceptor units is cut off by both the twisted nonplanar aromatic system and the ketone form of molecular structure. The molecule has a small computed dipole (6.78 Debyes) and a large computed band gap (E=3.33 eV)[2] which corresponds to a computed optical absorption at λ=372 nm. The D-B-A molecule is an optically transparent material in a visible range.

However, when an external e-field with an appropriate orientation is applied, the molecule tends to polarize in a direction of an external e-field. In order to reach its maximum polarization, that is, to reach its maximum p-pi delocalization state, the bi-fluorene transforms into coplanar conformation along with a structural tautomerization of a ketone to enol. This results in a fully polarized state with a huge dipole. Consequently, the molecular band gap is decreased dramatically. Both electrical conductivity and optical properties are substantially changed.

When an oppositely directed e-field is applied, electrostatic repulsion between the external e-field and the polarized molecular dipole forces the D-B-A molecule to rearrange both structurally and conformationally. To minimize charge repulsion, and minimize the potential energy build-up due to the incompatibility between the two, the segments of the bi-fluorene system of the bridging subunit begin to twist (approximately 31 degree angle) on a single bond between the two fluorene-rings, and at the same time, produce structural re-tautomerization from enol to ketone. Both structural and conformational rearrangements completely cut off the channel between the donor and the acceptor. The electronic communication between donor and acceptor units is once again cut off, and there is no more electronic delocalization through the entire molecular system. The optical absorption is shifted into the blue range, and the molecule is in a localized insulating state.

The D-B-A molecule may undergo a spectrum of changes of optical absorption during the e-field induced polarization and de-polarization process, extensible to color switch implementation. The D-B-A molecules are also usable as components of either monolayers or multiple layers in device applications.

The D-B-A molecule embodiments of the invention described herein have both electrical and optical applications. The D-B-A molecule embodiments include a class of e-field switchable digital dye material. The D-B-A molecule embodiments have applications as both microscopic and macroscopic reversible optical switches. For some embodiments, the D-B-A molecules function as electric field activated molecular switches that have an electric field induced band gap change that occurs via a molecular polarization and/or a tautomerization.

The energy barriers of the D-B-A molecules between states in a solid environment are small, and the switching speed is very fast due to a small conformational change in molecular structure between non- or partial polarized state to fully polarized state. Furthermore, device fabrication employing the D-B-A molecules is much simpler than fabrication using a conformation changeable dipole rotor/stator type of digital dye.

The D-B-A molecule embodiments of the invention described herein undergo substantial dipole changes under the influence of an electromagnetic field. The D-B-A molecules have responses similar to responses under an external e-field when they are exposed to a polarized light.

Other variations of D-B-A molecules are illustrated in FIGS. 9A-B 10A-B, 11A-B, 12A-B, and 13A-B, and show variations of e-field switchable D-B-A molecular structure through polarization and de-polarization processing. FIGS. 9A and 9B illustrate an e-field induced molecular polarization along with molecular tautomerization for a D-B-A molecule embodiment, molecule 2, shown in FIG. 9A. Molecule 2 in FIG. 9A is in a nonpolarized or partially polarized state. E(HOMO/LUMO)=3.69 eV and mu=12.67 Debyes. Molecule 2 passes through an e-field induced polarization or depolarization process along with a structurally ketone-enol tautomerization to form a structure shown in FIG. 9B. Both dipole and band gap change largely during the process. FIG. 9B shows molecule 2 in a fully polarized state. E(HOMO/LUMO)=1.83 eV and mu=44.03 Debyes.

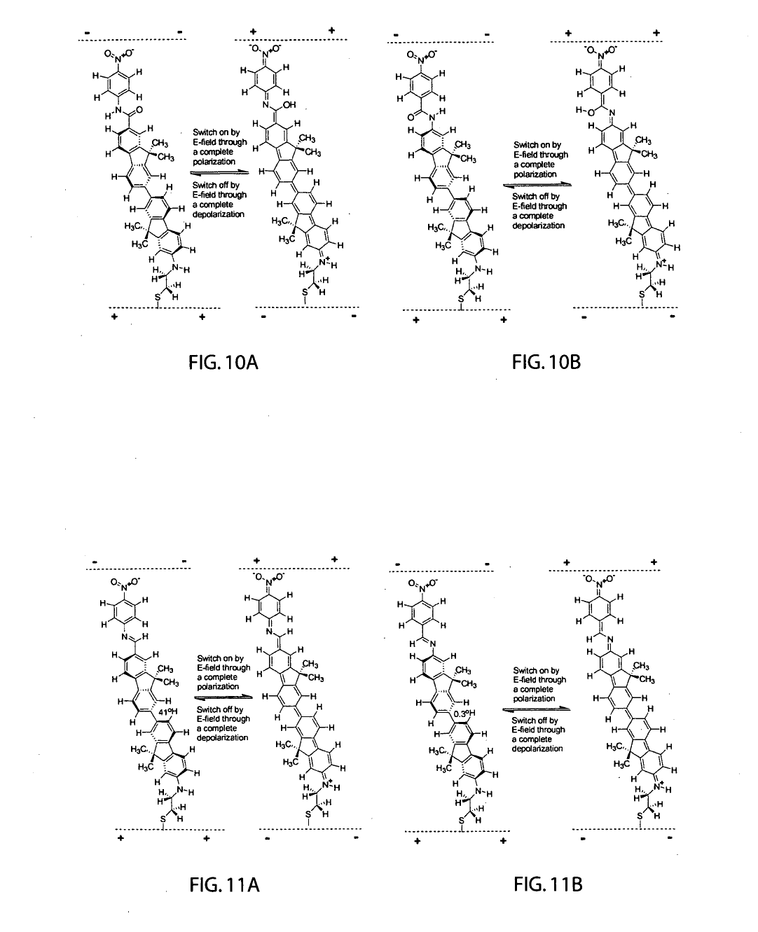

The D-B-A molecule embodiment, molecule 2, includes a —CH₂CO— group between the acceptor group and the bi-fluorene bridging subunit of the molecule. FIGS. 10A and 10B illustrate a molecular switch embodiment, molecule 3, in a nonpolarized or partially polarized state and in a fully polarized state. Molecule 3 is switched off and on by application of an e-field, which causes Molecule 3 to undergo complete polarization and complete depolarization. When the ketone side of the CH₂CO— group connecting to the bi-fluorene segment instead of the benzene ring of the acceptor, the molecular dipoles of both partially polarized and fully polarized states are increased. However, the dipole movement of the partial polarized state is nearly double, from computed dipole of 6.78 to 12.67 Debyes, and its fully polarized state is increased slightly, from a computed dipole of 41.7 to 44 Debyes, compared to its non-polarized states. For the D-B-A molecule of FIGS. 10A and 10B, the computed band gap change from partial polarized state to fully polarized state is larger (ΔE=2.07 eV), and for molecule 2, the computed band gap change during the polarization process is relatively smaller (ΔE=1.86 eV). The differences in band gap change and optical absorption shifts may be useful for different electrical and optical applications.

Molecules 3 and 4, illustrated in FIGS. 10A and 10B, have bridging subunits between the bi-fluorene and the acceptor group. Molecules 3 and 4 include an amide (—NHCO—) as a connecting group between the bi-fluorene ring and the benzene ring of the acceptor portion. Again, the amide group is capable of undergoing an amide-imide tautomerization during an e-field induced molecular polarization or de-polarization process. Similarly, both computed band gaps and molecular dipole display a great change during the e-field induced molecular polarization or de-polarization process.

Additional embodiments of the D-B-A molecules, molecule 5 and molecule 6, are illustrated in FIGS. 11A and 11B. Molecules 5 and 6 include an imine group (—N═CH—) as a bridging group between the bi-fluorene ring and the benzene ring of the acceptor portion. In these two particular molecular examples, the imine groups do not undergo a tautomerization during an e-field induced molecular polarization or de-polarization process. Both computed band gaps and molecular dipole moments experience a huge change during the e-field induced molecular polarization or de-polarization process. A change in molecule 5 from a non or partial polarized state to a fully polarized state is shown in FIG. 6A. The change occurs by switching molecule 5 “ON” and “OFF” by an e-field through a complete polarization and a complete depolarization. The E of the non or partial polarized state is 3.37 eV. The E of the fully polarized state of the molecule is 1.2 eV.

The non or partial polarized state of molecule 6 is shown in FIG. 11B. The fully polarized state of molecule 5 is also shown in FIG. 11B. The energy of the non or partial polarized state is 2.82 eV. The fully polarized state has an E of 1.0 eV.

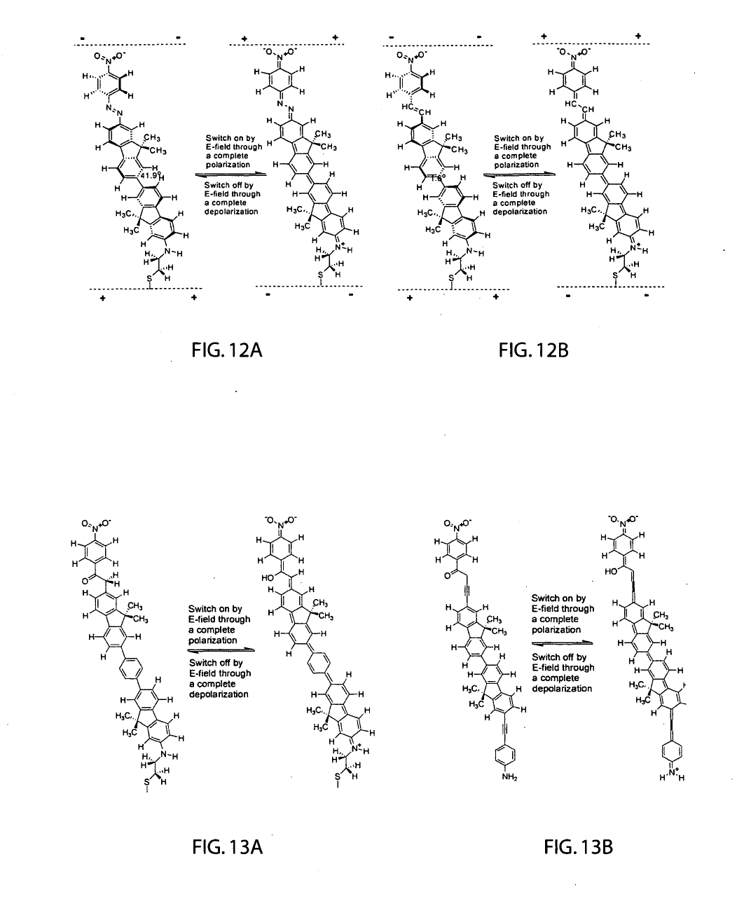

Additional embodiments of the D-B-A molecule, molecule 7 and molecule 8, are illustrated in FIGS. 12A and 12B. The molecule of FIG. 12A includes an azo group (—N═N—) as a bridging group between the bi-fluorene ring and a benzene ring of the acceptor portion. In this example, the azo group is similar to the imine group of molecules 5 and 6, and does not undergo any tautomerization during an e-field induced molecular polarization or de-polarization process, in an embodiment.

The computed molecular dipole moments display a substantial change, over six times the difference, from 9.5 to 59.93 Debyes, during an e-field induced molecular polarization or de-polarization process. However, the computed band gap change is smaller when compared to changes for molecules 1, 2, 3, 4, 5, and 6 during the e-field induced molecular polarization or de-polarization process. This property is usable for different display or optical applications.

Another D-B-A embodiment shown in FIG. 12B, includes an ethenyl group (—CH═CH—) as a connecting group between the bi-fluorene ring and the benzene ring of the acceptor portion. The ethenyl group does not undergo any tautomerization as occurs for molecules 5, 6, and 7 during an e-field induced molecular polarization or de-polarization process. The band gap and the molecular dipole moments experience a huge change during e-field induced molecular polarization and de-polarization processes for molecule 8, similarly to molecules 1, 2, 3, 4, 5, and 6.

One other D-B-A molecule embodiment, Molecule 9, illustrated in FIG. 13A, includes a benzene ring between two fluorene rings and includes a tautomerizable ketone group to connect both the middle segment and the benzene ring of the acceptor portion. The benzene positioned between two fluorene rings results in a double twisted conformation structure, and the ketone group remains in ketone form as well when the molecule is in a non-polarized state.

Molecule 10 includes a phenyl acetylene group to connect the donor (—NH₂) with one end of the bi-fluorene rings, and with acetylene group to link another end of the bi-fluorene ring through a tautomerizable ketone group to the acceptor portion, illustrated in FIG. 13B. The bi-fluorene rings remain in twisted conformation, and the ketone group remains in ketone form when the molecule is in a non-polarized state. Molecules 9 and 10 display properties similar to those of the molecule of FIG. 8 when under the influence of an e-field.

The computed molecular dipole moments display a huge change, of from about 6.7 to 51.9 Debyes for molecule 9 and 5.2 to 37.6 Debyes for the molecule of FIG. 13B, during an e-field induced molecular polarization or de-polarization process. The computed band gap change is similar to that of molecule 1.

The D-B-A molecule embodiments of the invention may change color when changing state. The molecule embodiments are usable for a wide variety of display devices or other applications enabled by a material that changes color or transforms from transparent to colored. The D-B-A molecule embodiments of the invention permit rapid, reversible, optical switching from a first “ON” state to a second “OFF” state.

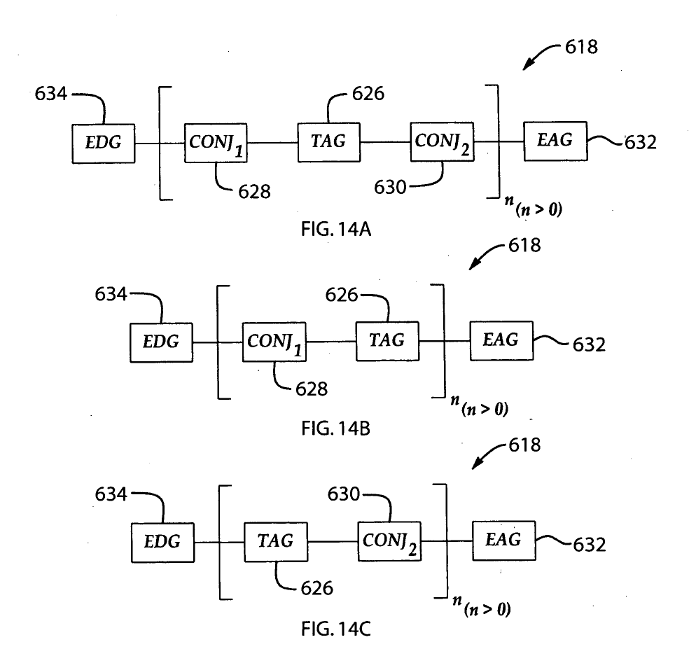

Referring now to FIGS. 14A through 14C, three alternate embodiments of the molecule 618 are shown. Generally, each embodiment of the molecule 618 has tautomerizable atomic group(s) (TAG), an electron-accepting group (EAG) (“acceptor”), an electron-donating group (EDG) (“donor”), and at least one conjugating fragment (CONJ). It is to be understood that the molecule 618 may be symmetrical or asymmetrical, as desired. It is to be further understood that generally the molecule 618 has a modest dielectric constant and is easily polarizable in the presence of an external electric field and/or electromagnetic field.

FIG. 14A shows an embodiment of the molecule 618 having a tautomerizable atomic group (TAG) 626. It is to be understood that the tautomerizable atomic group (TAG) 626 is structurally switchable between a conjugation-connected state and a conjugation-disconnected state, accordingly, when exposed to an external field. Examples of suitable tautomerizable atomic groups 626 include, but are not limited to ketones, amides, and combinations thereof. In a non-limitative example, the molecule 618 is an organic molecule, and the tautomerizable atomic group (TAG) 626 is an optically switchable molecular functional unit, an electrically switchable molecular functional unit, or both.

It is also understood that the tautomerizable atomic group (TAG) 626 can be a dual tautomerizable atomic group (DTAG). DTAG represents dual tautomerizable atomic functional group that can be classified into two general categories: 1) functionalized nitrogen containing heterocyclic dual-tautomerizable system (FNHDTS); and 2) an ortho-hydroxy dual-tautomerizable system (OHDTS). The FNHDTS can be divided further into three general sub-categories: 1) amino-substituted triazine dual-tautomerizable system (ASTDTS); 2) ortho-pyrrole conjugated imine dual-tautomerizable system (OPCIDTS); and 3) ortho-imidazole conjugated imine dual-tautomerizable system (OICIDTS).

The ortho-hydroxy dual-tautomerizable system OHDTS can be divided further into three general sub-categories: 1) an ortho-hydroxy conjugated azo dual-tautomerizable system (OHCADTS); 2) an ortho-hydroxy conjugated imine dual-tautomerizable system (OHCIDTS); and 3) an ortho-hydroxy conjugated ketone dual-tautomerizable system (OHCKDTS). The three sub-categories of the OHDTS can be divided even further depending on whether the conjugating system is aromatic hydrocarbon or heterocyclic ring, such as, for example: an ortho-hydroxy azo aromatic dual-tautomerizable system (OHMDTS); an ortho-hydroxy azo heterocyclic dual-tautomerizable system (OHHADTS); an ortho-hydroxy aromatic imine dual-tautomerizable system (OHAIDTS); an ortho-hydroxy heterocyclic imine dual-tautomerizable system (OHHIDTS); an ortho-hydroxy aromatic ketone dual-tautomerizable system (OHAKDTS); and an ortho-hydroxy heterocyclic ketone dual-tautomerizable system (OHHKDTS).

In the embodiment shown in FIG. 14A, a first conjugating fragment (CONJ₁) 628 is attached to one of the opposed ends of the tautomerizable atomic group (TAG) 626, and a second conjugating fragment (CONJ₂) 630 is attached to the other opposed end of the tautomerizable atomic group (TAG) 626. In this embodiment, it is to be understood that the conjugating fragments 628, 630 may be substantially the same or different. Further, the group including the first conjugating fragment (CONJ₁) 628, the tautomerizable atomic group (TAG) 626, and the second conjugating fragment (CONJ₂) 630 may be repeated such that there are more than one of each of the groups, 626, 628, 630 in the molecule 618, as denoted by the “n (n>0)” in FIG. 14A. Still further, generally the groups 626, 628, 630 are substantially linear such that the molecule 618 may be switched from a conjugation-connected state to a conjugation-disconnected state. Still further, in a non-limitative example, the substantially linear molecule 618 may have additional conjugating fragments (non-limitative examples of which include biphenyls, bifluorenyls, and aromatic hydrocarbons) substantially linearly attached to the first and/or second conjugating fragments (CONJ₁) 628, (CONJ₂) 630.

Generally, suitable examples of the conjugating fragment(s) 628, 630 include, but are not limited to, at least one of —CH═CH—, —CR₁═CR₂—, acetylenes, azo groups, aromatic hydrocarbons, substituted aromatic hydrocarbons, aromatic heterocyclic compounds, and mixtures thereof.

The aromatic hydrocarbon or substituted aromatic hydrocarbon conjugated fragment(s) include, but are not limited to at least one of single aromatics (non-limitative examples of which include benzene and substituted benzene) or poly-aromatics (non-limitative examples of which include naphthalene and its derivatives, acenaphthalene and its derivatives, anthracene and its derivatives, phenanthrene and its derivatives, benzanthracene and its derivatives, dibenzanthracene and its derivatives, fluorene and its derivatives, benzofluorene and its derivatives, fluoranthene and its derivatives, pyrene and its derivatives, benzopyrene and its derivatives, naphthopyrene and its derivatives, chrysene and its derivatives, perylene and its derivatives, benzoperylene and its derivatives, pentacene and its derivatives, coronene and its derivatives, tetraphenylene and its derivatives, triphenylene and its derivatives, and decacyclene and its derivatives), and mixtures thereof.

Examples of suitable aromatic heterocyclic compound conjugated fragment(s) include, but are not limited to at least one of single ring heterocycles or fused ring heterocycles. In an embodiment, the single ring heterocycle is a 5-membered ring or a 6-membered ring, each of which may have one or more heteroatoms in the ring. The heteroatom(s) in the aromatic heterocycles may be oxygen, sulfur, selenium, nitrogen, phosphorus, and/or combinations thereof. In another embodiment, the fused ring heterocycle is a 5-membered fused aromatic heterocycle or a 6-membered fused aromatic heterocycle.

Non-limitative examples of the single ring 5-membered heterocycles include at least one of furan and its derivatives, pyrrole and its derivatives, thiophene and its derivatives, porphine and its derivatives, pyrazole and its derivatives, imidazole and its derivatives, triazole and its derivatives, isoxazole and its derivatives, oxadiazole and its derivatives, thiazole and its derivatives, isothiazole and its derivatives, thiadiazole and its derivatives, mixtures thereof, and the like.

In an embodiment, the single ring 6-membered heterocycles includes, but is not limited to at least one of pyridine and its derivatives, pyridazine and its derivatives, pyrimidine and its derivatives, uracil and its derivatives, azauracil and its derivatives, pyrazine and its derivatives, triazine and its derivatives, mixtures thereof, and the like.

Non-limitative examples of the 5-membered fused aromatic heterocycles include at least one of indole and its derivatives, carbazole and its derivatives, benzofuran and its derivatives, dibenzofuran and its derivatives, thianaphthene and its derivatives, dibenzothiophene and its derivatives, indazole and its derivatives, azaindole and its derivatives, iminostilbene and its derivatives, norharman and its derivatives, benzimidazole and its derivatives, benzotriazole and its derivatives, benzisoxazole and its derivatives, anthranil and its derivatives, benzoxazole and its derivatives, benzothiazole and its derivatives, triazolopyrimidine and its derivatives, triazolopyridine and its derivatives, benzselenazole and its derivatives, purine and its derivatives, mixtures thereof, and the like.

Examples of suitable 6-membered fused aromatic heterocycles include, but are not limited to at least one of quinoline and its derivatives, benzoquinoline and its derivatives, acridine and its derivatives, isoquinoline and its derivatives, benzacridine and its derivatives, phenanthridine and its derivatives, phenanthroline and its derivatives, phenazine and its derivatives, quinoxaline and its derivatives, mixtures thereof, and the like.

As depicted in FIG. 14A, each of the first and second conjugating fragments (CONJ₁) 628, (CONJ₂) 630 has an additional group attached thereto. In this embodiment, an electron-donating group (EDG) 634 is attached to one of the conjugating fragments (CONJ₁) 628, and an electron-accepting group (EAG) 632 is attached to the other of the conjugating fragments (CONJ₂) 630. It is to be understood that the electron-donating group (EDG) 634 and the electron-accepting group (EAG) 632 may be attached to either of the conjugating fragment(s) 628, 630, as long as each of the groups (EDG) 634, (EAG) 632 are located at opposed ends of the tautomerizable atomic group (TAG) 626.

It is to be understood that the electron-accepting group (EAG) 632 and the electron-donating group (EDG) 634 may be substantially the same or different atomic groups. Generally, when they are different groups, the electron-donating group (EDG) 634 is less electronegative, or more electropositive, than the electron-accepting group (EAG) 632. Further, both the electron-accepting group (EAG) 632 and the electron-donating group (EDG) 634 may be a single electron-accepting or electron-donating atom or may be an electron-accepting or an electron-donating atomic group (a non-limitative example of which includes an aromatic ring having an electron-accepting or electron-donating atom within the ring).

Non-limitative examples of suitable electron-accepting groups (EAG) 632 include at least one of hydrogen; hetero atoms including at least one of N, O, S, P, F, Cl, and Br; functional groups containing at least one of the hetero atoms; saturated hydrocarbons; unsaturated hydrocarbons; substituted hydrocarbons; carboxylic acids, carboxylic acid derivatives; carboxylic esters; amides; nitro groups; nitrites; carbonyls; cyano groups; imines; azo groups; sulfuric acids; sulfuric acid derivatives, such as, for example, sulfuric esters and sulfuric amides; phosphoric acids; phosphoric acid derivatives such as, for example, phosphoric esters and phosphoric amides; and mixtures thereof.

Examples of suitable electron-donating groups (EDG) 634 include, but are not limited to functional groups containing at least one hetero atom including at least one of B, Si, I, N, O, S, and P; hydrogen; amines; OH; SH; ethers; saturated hydrocarbons; unsaturated hydrocarbons; substituted hydrocarbons; and mixtures thereof.

It is to be understood that the materials described herein in reference to FIG. 14A may be used to form the embodiments shown in FIGS. 14B and 14C.

FIG. 14B depicts an alternate embodiment of the molecule 618. One conjugating fragment ((CONJ₁) 628, for example) is attached to one of the opposed ends of the tautomerizable atomic group (TAG) 626, and an electron-accepting group (EAG) 632 is attached directly to the other opposed end of the tautomerizable atomic group (TAG) 626. In this embodiment, the electron-donating group (EDG) 634 is attached to the conjugating group (CONJ₁) 628. It is to be understood that in this embodiment, the group including the conjugating fragment (CONJ₁) 628 and the tautomerizable atomic group (TAG) 626 may be repeated such that there are more than one of each of the groups, 626, 628 in the molecule 618, as denoted by the “n (n>0)” in FIG. 14B.

FIG. 14C depicts still a further embodiment of the molecule 618. In this example embodiment, one conjugating fragment ((CONJ₂) 630, for example) is attached to one of the opposed ends of the tautomerizable atomic group (TAG) 626, and an electron-donating group (EDG) 634 is attached directly to the other opposed end of the tautomerizable atomic group (TAG) 626. In this embodiment, the electron-accepting group (EAG) 632 is attached to the conjugating group (CONJ₂) 630. It is to be understood that in this embodiment, the group including the conjugating fragment (CONJ₂) 630 and the tautomerizable atomic group (TAG) 626 may be repeated such that there are more than one of each of the groups, 626, 630 in the molecule 618, as denoted by the “n (n>0)” in FIG. 14C.

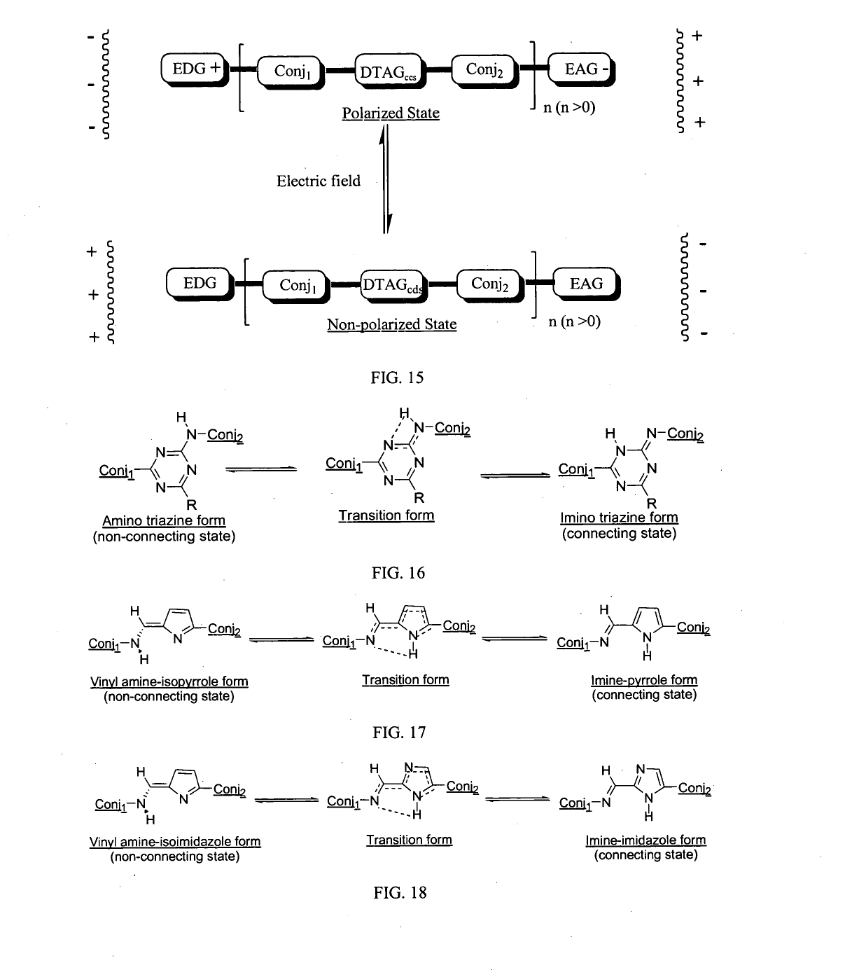

FIG. 15 generally illustrates how a switchable molecule polarizes or de-polarizes under the influence of an external field. As shown in FIG. 15, the molecule, with a dual tautomerizable atomic group (DTAG) inserted in between the two conjugating fragments (Conj₁ and Conj₂), will be either polarized or non-polarized under the influence of external e-field.

As shown on the top portion of the FIG. 15, the molecule will be partially polarized initially under the influence of an external electrical field. The partial polarization, in turn, initiates an “on” state tautomerization of the DTAG to a conjugation connected state (DTAG_{ccs}, an “on” state). The DTAG_{ccs} bridges two adjacent conjugating segments and enables concomitant delocalization of π electrons throughout the molecule. The π-bridge enables the charge transfers between the EDG and EAG, and results in larger molecular dipole and smaller energy gap between the highest occupied molecular orbital (HOMO) and the lowest unoccupied molecular orbital (LUMO).

On the other hand, when a reversed external electrical field is applied, electrostatic repulsion between the external field and the localized e-field from the polarized molecular dipole increases potential energy of the molecule, as shown on the bottom portion of the FIG. 15. The tendency of reducing its potential energy will prompt the molecule to partially depolarize to minimize the charge repulsion. The partial depolarization of the molecule, in turn, initiates an “off” state tautomerization of the DTAG. The “off” state of the DTAG is a conjugation-disconnected state (DTAGcds). It further enhances the depolarization of the molecule by breaking up the extended conjugation and eliminating any intra-molecular charge transfers between the donor and acceptor. The full conjugation of π electrons within the entire molecule is disrupted in the “off” state. Consequently, this results in a smaller molecular dipole, a larger HOMO and LUMO band gap of the molecule, and in turn, blue-shifting the absorption characteristics of the molecule and a transparent film when the energy gap corresponds to ultra-violet or more energetic wavelengths.

As previously discussed, the DTAG can be classified into two categories: functionalized nitrogen containing heterocyclic dual-tautomerizable systems (FNHDTS) and ortho-hydroxy dual-tautomerizable systems (OHDTS). Three types of DTAGs within the FNHDTS category include amino-substituted triazine dual-tautomerizable systems (ASTDTS), ortho-pyrrole conjugated imine dual-tautomerizable systems (OPCIDTS), and ortho-imidazole conjugated imine dual-tautomerizable systems (OICIDTS). FIGS. 16-18 illustrate specific examples of the sub-categories of the FNHDTS and generally illustrate tautomerization of FNHDTS's.

FIG. 16 illustrates an amino-triazine/imino-isotriazine tautomerization of an ASTDTS between the two conjugating fragments (Conj₁ and Conj₂). As shown in the right structure of FIG. 16, the DTAG can undergo an amino-triazine/imino-isotriazine tautomerization via a 1,3-proton migration process. There are two sets of tautomeric structures for the ASTDTS: 1) an amino-triazine set that is designated as the “off” state for the molecule; and 2) an imino-isotriazine set that is designated as the “on” state for the molecule.

When the ASTDTS is in its “on” state imino-isotriazine structure, a good π-bridge is formed within the ASTDTS. All conjugating fragments including the π-bridge are in a coplanar conformation. This enables an extended conjugation throughout the entire molecule. Consequently, this results in a smaller HOMO/LUMO band gap of the molecule. However, when the ASTDTS in its “off” state amino-triazine structure, a π-break is created between the two adjacent conjugating ends (Conj₁ and Conj₂). The π-break within the amino-triazine structure disrupts the extended conjugation within the molecule, which results in p- and/or 90 -electron localization within each fragment instead of delocalization throughout the entire molecule. Consequently, this results in a larger HOMO/LUMO band gap in the molecule.

FIG. 17 illustrates an imine-pyrrole/vinyl amine-isopyrrole tautomerization of an OPCIDTS between the two conjugating fragments (Conj₁ and Conj₂). As shown in the right structure of FIG. 17, the OPCIDTS can undergo an imine-pyrrole/vinyl amine-isopyrrole tautomerization via a 1,4-proton migration process. There are two sets of tautomeric structures for the OPCIDTS: 1) a vinyl amine-isopyrrole structure that is designated as the “off” state for the molecule; and 2) an imine-pyrrole set that is designated as the “on” state for the molecule.

When the OPCIDTS is in its “on” state imine-pyrrole structure, a good π-bridge is formed within the imine-pyrrole structure. All conjugating fragments including the π-bridge are in a coplanar conformation. This enables an extended conjugation throughout the entire molecule. Consequently, this results in a smaller HOMO/LUMO band gap of the molecule. However, when the OPCIDTS in its “off” state amine-isopyrrole structure, a π-break is created between the two adjacent conjugating ends (Conj₁ and Conj₂). The π-break within the amino-triazine structure disrupts the extended conjugation within the molecule, which results in p- and/or π-electron localization within each fragment instead of delocalization throughout the entire molecule. Consequently, this results in a larger HOMO/LUMO band gap in the molecule.

FIG. 18 illustrates an imine-imidazole/vinyl amine-isoimidazole tautomerization of an OICIDTS between the two conjugating fragments (Conj₁ and Conj₂). As shown in the right structure of FIG. 18, the OICIDTS can undergo a vinyl amine-isoimidazole/imine-imidazole tautomerization via a 1,4-proton migration process. There are two sets of tautomeric structures for the OICIDTS. One of the sets, the vinyl amine-isoimidazole set, is designated as the “off” state for the molecule, and another set, the imine-imidazole set, is designated as the “on” state for the molecule.

When the OICIDTS in its “on” state imine-imidazole structure, a good π-bridge is formed within the imine-imidazole structure. All conjugating fragments including the π-bridge are in a coplanar conformation. This enables an extended conjugation throughout the entire molecule and a smaller HOMO/LUMO band gap of the molecule. However, when the OICIDTS in its “off” state vinyl amine-isoimidazole structure, a π-break is created between the two adjacent conjugating ends (Conj₁ and Conj₂). The π-break within the vinyl amine-isoimidazole structure disrupts the extended conjugation within the molecule, and results in p- and/or π-electrons localization within each fragment instead of delocalization throughout the entire molecule. Consequently, this results in a larger HOMO/LUMO band gap in the molecule.

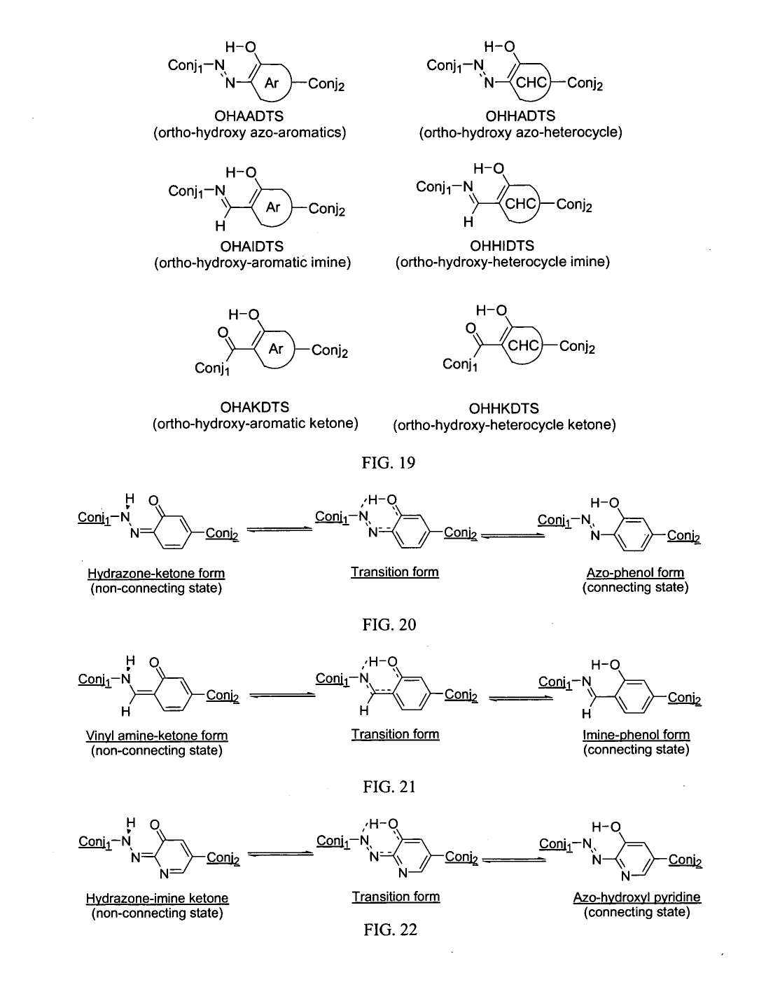

FIG. 19 generally illustrates six types of ortho-hydroxy dual-tautomerizable systems (OHDTS), namely: ortho-hydroxy azo aromatic dual-tautomerizable systems (OHMDTS); ortho-hydroxy azo heterocyclic dual-tautomerizable systems (OHHADTS); ortho-hydroxy aromatic imine dual-tautomerizable systems (OHAIDTS); ortho-hydroxy heterocyclic imine dual-tautomerizable systems (OHHIDTS); ortho-hydroxy aromatic ketone dual-tautomerizable systems (OHAKDTS); and ortho-hydroxy heterocyclic ketone dual-tautomerizable systems (OHHKDTS). As shown in FIG. 6, the Ar in the ring is a hydrocarbon aromatic system including either single ring aromatics (i.e. benzene or substituted benzene) or poly-aromatics (i.e. naphthalene or its derivatives, acenaphthalene or its derivatives, anthracene or its derivatives, phenanthrene or its derivatives, benzanthracene or its derivatives, dibenzanthracene or its derivatives, fluorene or its derivatives, benzofluorene or its derivatives, fluoranthene or its derivatives, pyrene or its derivatives, benzopyrene or its derivatives, naphthopyrene or its derivatives, chrysene or its derivatives, perylene or its derivatives, benzoperylene or its derivatives, pentacene or its derivatives, coronene or its derivatives, tetraphenylene or its derivatives, triphenylene or its derivatives, decacyclene or its derivatives.

The CHC in the ring stands for conjugated heterocyclic system. The conjugated heterocyclic system can be either a single ring heterocycle or a fused ring heterocycles. The single ring heterocycle can either be a 5-membered-ring, or 6-membered-ring with one or more heteroatom in the ring. The heteroatom in the aromatic heterocycles can be an oxygen, sulfur, selenium, nitrogen, or phosphor atom. The single ring of 5-membered-heterocycles can be one of followings: furan and its derivatives, pyrrole and its derivatives, thiophene and its derivatives, porphine and its derivatives, pyrazole and its derivatives, imidazole and its derivatives, triazole and its derivatives, isoxazole and its derivatives, oxadiazole and its derivatives, thiazole and its derivatives, isothiazole and its derivatives, thiadiazole and its derivatives.

The single ring of 6-membered-heterocycles can include pyridine and its derivatives, pyridazine and its derivatives, pyrimidine and its derivatives, uracil and its derivatives, azauracil and its derivatives, pyrazine and its derivatives, triazine and its derivatives. The fused ring heterocycles can be a 5-membered fused atomic heterocycle or a 6-membered fused aromatic heterocycle. The 5-membered fused atomic heterocycle group can include indole and its derivatives, carbazole and its derivatives, benzofuran and its derivatives, dibenzofuran and its derivatives, thianaphthene and its derivatives, dibenzothibphene and its derivatives, indazole and its derivatives, azaindole and its derivatives, iminostilbene and its derivatives, norharman and its derivatives, benzimidazole and its derivatives, benzotriazole and its derivatives, benzisoxazole and its derivatives, anthranil and its derivatives, benzoxazole and its derivatives, benzothiazole and its derivatives, triazolopyrimidine and its derivatives, triazolopyridine and its derivatives, benzselenazole and its derivatives, and purine and its derivatives. The 6-membered fused atomic heterocycle group can include quinoline and its derivatives, and its derivatives, benzoquinoline and its derivatives, acridine and its derivatives, iso quinoline and its derivatives, benzacridine and its derivatives, phenathridine and its derivatives, phenanthroline and its derivatives, and phenazine and its derivatives, quinoxaline and its derivatives.

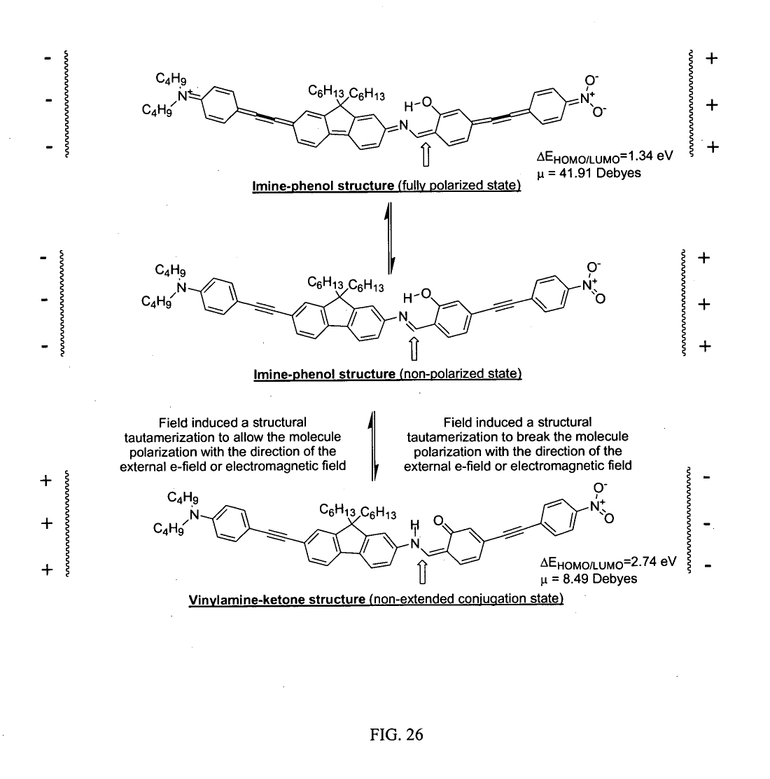

FIGS. 20 through 25 provide six examples of different sub-categories of OHDTS and illustrate generally how their tautomerization works. FIG. 26 depicts a specific example of e-field induced property change of a molecule having only one OHDTS in its structure.

FIG. 20 illustrates an azo-phenol/hydrazone-ketone tautomerization of an OHAADTS between the two conjugating fragments (Conj₁ and Conj₂). As shown in the right structure of FIG. 20, the OHAADTS can undergo an azo-phenol/hydrazone-ketone tautomerization via a 1,5-proton migration process. There are two sets of tautomeric structures for the OHMDTS: 1) a hydrazone-ketone set, designated as the “off”0 state for the molecule; and 2) an azo-phenol set, designated as the “on” state for the molecule. When the OHAADTS is in its “on” state azo-phenol structure, a good π-bridge is formed within the azo-phenol structure. All conjugating fragments including the π-bridge are in a coplanar conformation, enabling an extended conjugation throughout the entire molecule and a smaller HOMO/LUMO band gap of the molecule.

However, when the OHMDTS in its “off” state hydrazone-ketone structure, a π-break is created between the two adjacent conjugating ends (Conj₁ and Conj₂). The π-break within the hydrazone-ketone structure disrupts the extended conjugation within the molecule, and results in p- and/or π-electrons localization within each fragment instead of delocalization throughout the entire molecule. Consequently, this results in a larger HOMO/LUMO band gap in the molecule.

FIG. 21 illustrates a vinyl amine-ketone/imine-phenol tautomerization of an OHAIDTS between the two conjugating fragments (Conj₁ and Conj₂). As shown in the right structure of FIG. 21, the OHAIDTS can undergo a vinyl amine-ketone/imine-phenol tautomerization via a 1,5-proton migration process. There are two sets of tautomeric structures for the OHAIDTS: 1) a vinyl amine-ketone set, designated as the “off” state for the molecule; and 2) a imine-phenol set, designated as the “on” state for the molecule. When the OHAIDTS in its “on” state imine-phenol structure, a good π-bridge is formed within the imine-phenol structure. All conjugating fragments including the π-bridge are in a coplanar conformation, enabling an extended conjugation throughout the entire molecule and a smaller HOMO/LUMO band gap of the molecule.

However, when the OHAIDTS in its “off” state vinyl amine-ketone structure, a □-break is created between the two adjacent conjugating ends (Conj₁ and Conj₂). The π-break within the vinyl amine-ketone structure disrupts the extended conjugation within the molecule, and results in p- and/or π-electrons localization within each fragment instead of delocalization throughout the entire molecule. Consequently, this results in a larger HOMO/LUMO band gap in the molecule.

Both the tautomerizable atomic groups shown in FIGS. 20 and 21 have an ortho-hydroxyl group on the benzene ring in an ortho position to the azo or imine group. However, the substituted benzene ring shown in FIGS. 20 and 21 are only two specific examples for conjugated ring systems. Conjugated ring systems can also include, for example, a single aromatic ring, poly-aromatics (two or more fused aromatic rings), a single heterocycle ring, or fused poly-heterocycle rings.

FIG. 22 illustrates a hydrazone-imine ketone/azo-hydroxyl pyridine tautomerization of an OHHADTS between the two conjugating fragments (Conj₁ and Conj₂). Similarly with the OHAADTS as shown in the right structure of FIG. 20, the OHHADTS can also undergo a hydrazone-ketone/azo-hydroxyl pyridine tautomerization via a 1,5-proton migration process. There are two sets of tautomeric structures for the OHHADTS: a hydrazone-ketone set, designated as the “off” state for the molecule: and 2) an azo-hydroxyl pyridine set, designated as the “on” state for the molecule. When the OHHADTS in its “on” state azo-hydroxyl pyridine structure, a good π-bridge is formed within the azo-hydroxyl pyridine structure. All conjugating fragments including the π-bridge are in a coplanar conformation, enabling an extended conjugation throughout the entire molecule and a smaller HOMO/LUMO band gap of the molecule.

However, when the OHHADTS in its “off” state hydrazone-ketone structure, a π-break is created between the two adjacent conjugating ends (Conj₁ and Conj₂). The π-break within the hydrazone-ketone structure disrupts the extended conjugation within the molecule, and results in p- and/or π-electrons localization within each fragment instead of delocalization throughout the entire molecule. Consequently, this results in a larger HOMO/LUMO band gap in the molecule.

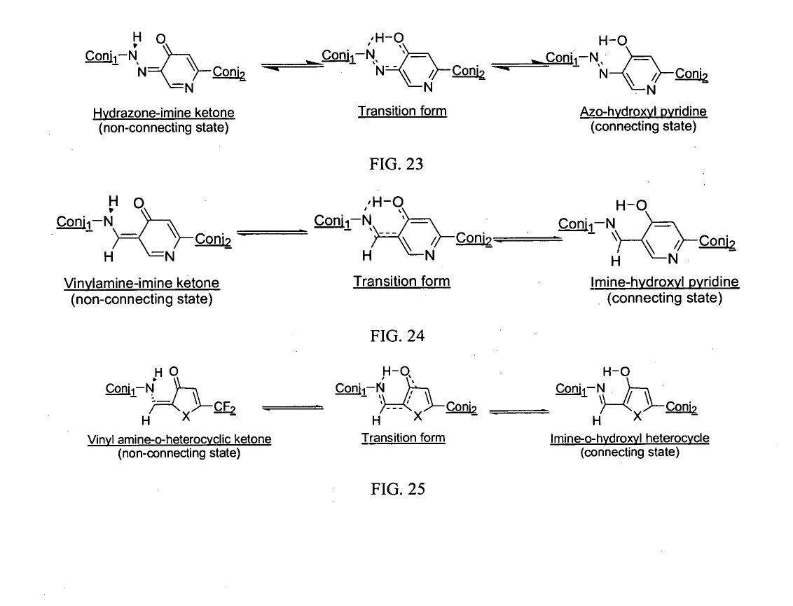

FIG. 23 illustrates another example of the hydrazone-imine ketone/azo-hydroxyl pyridine_tautomerization of a different OHHADTS between the two conjugating fragments (CF₁ and CF₂). The OHHADTS shown here is similar to that shown in FIG. 22, except for the position of nitrogen atom in the pyridine ring. The OHHADTS of FIG. 23 behaves similarly to the one shown in FIG. 9 and undergoes a hydrazone-imine ketone/azo-hydroxyl pyridine tautomerization via a 1,5-proton migration process.

FIG. 24 illustrates a hydrazone-imine ketone/imine-hydroxyl pyridine tautomerization of an OHHIDTS between the two conjugating fragments (Conj₁ and Conj₂). The OHHIDTS of FIG. 24 are similar to those shown in FIG. 21, except for having a substituted pyridine (a simple one-heteroatom-six-member heterocycle unit) instead of a substituted benzene fragment. Similarly, as shown in the right structure of FIG. 24, the OHHIDTS can undergo a hydrazone-imine ketone/imine-hydroxyl pyridine tautomerization via a 1,5-proton migration process. There are two sets of tautomeric structures for the OHHIDTS: 1) a hydrazone-imine ketone set, designated as the “off” state for the molecule; and 2) an imine-hydroxyl pyridine set, designated as the “on” state for the molecule.

When the OHHIDTS in its “on” state imine-hydroxyl pyridine structure, a good π-bridge is formed within the imine-hydroxyl pyridine structure. All conjugating fragments including the π-bridge are in a coplanar conformation. This enables an- extended conjugation throughout the entire molecule. Consequently, this results in a smaller HOMO/LUMO band gap of the molecule.

However, when the OHHIDTS in its “off” state hydrazone-imine ketone structure, a π-break is created between the two adjacent conjugating ends (Conj₁ and Conj₂). The π-break within the hydrazone-imine ketone structure disrupts the extended conjugation within the molecule, and results in p- and/or π-electrons localization within each fragment instead of delocalization throughout the entire molecule. Consequently, this results in a larger HOMO/LUMO band gap in the molecule.

FIG. 25 illustrate another example of vinyl amine-heterocyclic ketone/imine-o-hydroxyl heterocycle tautomerization of an OHHIDTS between the two conjugating fragments (CF₁ and CF₂). The OHHIDTS of FIG. 25 is similar to that shown in FIG. 24, except that it is a substituted simple one-heteroatom-five-member heterocycle fragment instead of a substituted simple one-heteroatom-six-member heterocycle fragment. The X in the five-member heterocyclic structure can be, for example N, O, S, or Se. As shown in the right structure of FIG. 25, this five-member heterocyclic OHHIDTS undergoes a vinyl amine-heterocyclic ketone/imine-o-hydroxyl heterocycle tautomerization via a 1,5-proton migration process. There are two sets of tautomeric structures for this OHHIDTS: 1) a vinyl amine-heterocyclic ketone set, designated as the “off” state for the molecule; and 2) an imine-o-hydroxyl heterocycle set, designated as the “on” state for the molecule. When the OHHIDTS is in its “on” state imine-o-hydroxyl heterocycle structure, a good π-bridge is formed within the imine-o-hydroxyl heterocycle structure. This results in a smaller HOMO/LUMO band gap of the molecule. When the OHHIDTS in its “off” state vinyl amine-heterocyclic ketone structure, a π-break is created between the two adjacent conjugating ends (Conj₁ and Conj₂). This results in a larger HOMO/LUMO band gap in the molecule.

FIG. 26 depicts a specific example of e-field induced property change of the molecule with only one OHAADTS in its structure. The OHAADTS can be one of the six specific types of the OHDTS. This particular exemplary molecule is constructed with an electron-donating group (N,N-di-n-butyl amino-phenyl acetylene, (C₄H₉)₂N—C₆H₄—CC—), an electron-accepting group (4-nitro-phenyl acetylene, —CC—C₆H₄—NO₂) along with a 9,9,-di-n-hexyl fluorene conjugating fragments and a 2-imine-phenol (—N═CH—C₆H₄(OH)—) type of OHAIDTS. The electron-donating group (N,N-di-n-butyl amino-phenyl acetylene, (C₄H₉)₂N—C₆H₄—CC—) is linked with one end of the 9,9,-di-n-hexyl fluorene conjugating fragment through a acetylene linkage. The electron-accepting group (4-nitro-phenyl acetylene, —CC—C₆H₄—NO₂) in connected directly at 5-position with benzene ring of the 2-imine-phenol type of OHAIDTS through acetylene unit. The 2-imine-phenol (—N═CH—C₆H₄(OH)—) type of OHAIDTS is inserted between the 9,9,-di-n-hexyl fluorene conjugating fragment and the electron-accepting group (4-nitro-phenyl acetylene, —CC—C₆H₄—NO₂). As shown in the FIG. 21, the OHAIDTS which is built in within the molecule can undergo a vinyl amine-imine ketone/imine-phenol tautomerization via a 1,5-proton migration process.

When this particular molecule is in a non-polarized state, its OHAIDTS will tend to stay in its “off” state, as shown on the bottom part of the FIG. 26. Consequently, the molecule has a small dipole (μ=8.49 Debyes) and large band gap (ΔE_{HOMO/LUMO}=2.74 eV).

When an external e-field with the appropriate orientation is applied, the molecule will tend to be polarized to align with the direction of the external e-field, as shown on the top portion of the FIG. 26. The molecule will be partially polarized initially under the influence of an external electrical field. The partial polarization, in turn, initiates an “on” state tautomerization of the OHAIDTS to an imine-phenol structure. A good π-bridge is formed within the imine-phenol structure. All conjugating fragments including the π-bridge are in a coplanar conformation in such state. This enables an concomitant delocalization of π electrons throughout the molecule. The π-bridge enables the charge transfers between the electron-donating group and the electron-accepting group. Consequently, this results in larger molecular dipole (μ=41.91 Debyes) and smaller molecular band gap (ΔE_{HOMO/LUMO}=1.34 eV).

In contrast, when a reversed external electrical field is applied, electrostatic repulsion between the external field and the localized e-field from the polarized molecular dipole increases potential energy of the molecule, as shown on the bottom portion of the FIG. 26. The tendency of decreasing its potential energy will prompt the molecule to partial depolarize first to minimize the charge repulsion. The partial depolarization of the molecule, in turn, initiates a “off” state tautomerization of the OHAIDTS. The “off” state of the OHAIDTS is a vinyl amine-imine ketone structure. It further enhances the depolarization of the molecule by breaking up the extended conjugation and eliminating any intra-molecular charge transfers between the donor and acceptor. The full conjugation of π electrons within the entire molecule is disrupted in this “off” state. Consequently, this results in a smaller molecular dipole (μ=8.49 Debyes) a larger HOMO and LUMO band gap of the molecule (ΔE_{HOMO/LUMO}=2.74 eV). This results in essentially blue-shifting the absorption characteristics of the molecule.

In the previously described donor-switchable bridge-acceptor or D-B-A system, the switchable middle-bridging portion is made up of one or more conjugating segments, and linked with one or more dual-tautomerizable function atomic groups(s) (DTAG). The DTAG here refers to a set of two adjacent atomic groups that can undergo structural tautomerization simultaneously from one set to another set. One of the two sets of the DTAG is designated as “on” state for the molecule, and the other set is designated as “off “state for the molecule. When the DTAG in its “on” state, a good π-bridge is created between two adjacent conjugated fragments. The π-bridge is built up from a planar bond alternation pathway of single and double bonds. The bond alternation of single-double-bonds is an essential quantum factor for a good extended conjugation in a molecule. This enables p- and/or π-electrons delocalization throughout the molecular system. The π-bridge connects both the donor and acceptor through an extended conjugation system. This results in a smaller HOMO/LUMO band gap, and red shifted optical absorption of the molecule.

While several embodiments have been described in detail, it will be apparent to those skilled in the art that the disclosed embodiments may be modified. Therefore, the foregoing description is to be considered exemplary rather than limiting.

What is claimed is:

1. An electronically addressable display comprising:
a substrate;
at least one polarization-type, electrical field switchable molecular colorant associated with the substrate;
an addressing device mounted for selectively switching the at least one molecular colorant between at least two visually distinguishable states.

2. The display of claim 1, wherein a first of the two distinguishable states is a transparent state.

3. The display of claim 1, wherein a second of the two distinguishable states is a color state.

4. The display of claim 1, wherein the at least one molecular colorant comprises:
a donor subunit;
an acceptor subunit; and
an aromatic bridging subunit comprising one or more bridging groups to bond the donor subunit to the aromatic bridging subunit and to bond the acceptor subunit to the aromatic bridging subunit, wherein the aromatic bridging subunit conforms in a manner effective to polarize and to de-polarize the molecular switch at a low electric field voltage.

5. The display of claim 4, wherein the aromatic bridging subunit conforms to a position out the plane of the aromatic donor subunit and out of plane of the aromatic acceptor subunit when the molecular switch is non-polarized.

6. The display of claim 4, wherein the aromatic bridging subunit comprises a bi-phenyl, adjacent aromatic ring system.

7. The display of claim 4, wherein the aromatic bridging subunit comprises more than one bi-phenyl aromatic ring systems.

8. The display of claim 7, wherein the bi-phenyl, adjacent ring system comprises:

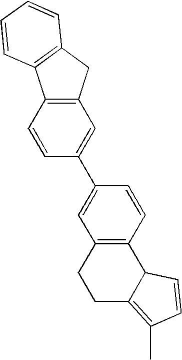

9. The display of claim 9, wherein the bi-phenyl, adjacent ring systems are selected from the group consisting of benzene, thiophene, pyrrole, furan, pyridine, thiophene or its derivatives, pyrrole and its derivatives, furan and its derivatives, and pyridine and its derivatives.

10. The display of claim 4, wherein the aromatic bridging subunit comprises an isolated conjugated system.

11. The display of claim 4, wherein the aromatic bridging subunit comprises twisted aromatic rings at each of two ends of the aromatic bridging subunit.

12. The display of claim 4, wherein the at least one molecular colorant comprises the following structure: 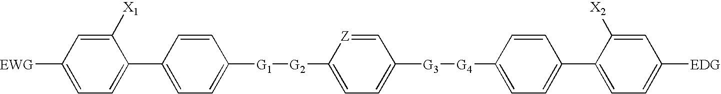
wherein “EWG” is the electron withdrawing group (or acceptor) and is selected from a group consisting of —C(═O)H, —C(═O)R₃, —C(═O)OR₃, —C(═O)OH, —CN, —N═O, —NO₂, —SO₂OH, —N═N—, CH═NR₃, —CR₃═NR₄, —C═C(CN)₂, —C═C(COR₃)₂, —C═C(CO₂R₃)₂, —C═C(COR₃)CO₂R₄, —SO₂OR₃, —S(═O)—R₃, —SO₂R₃, —BH₂, —BHR₃, —BR₃R₄, —PO₃H₂, —PO₃R₃R₄, wherein R₃ and R₄ are substituents independently selected from linear alkyl, branched alkyl, cyclic alkyl, and an aromatic ring system, and wherein the alkyl substituents are substituted or unsubstituted. “EDG” is the electron donating group (or donor) and is selected from a group consisting of —O—, —OH, —OR₁, —NH—, —NH₂, —NHR₁, —NR₁R₂, —PR₁R₂, —PHR₁, —S—, —SH, —SR₁, F, Cl, Br, and I, wherein R₁ and R₂ are substituents independently selected from linear alkyl, branched alkyl, cyclic alkyl, and an aromatic ring system, and wherein the alkyl substituents are substituted or unsubstituted. X₁ and X₂ are independently selected from a group consisting of hydrogen, F, Cl, Br, and I, —OH, —SH, —NH₂; and substituted alkyl groups. G₁-G₂ and G₃-G₄ are independently selected from a group consisting of —CH═CH—, —CH═CR₅—, —CR₅═CR₆—, —CH₂C(═O)—, —CR₅HC(═O)—, —CC—, —N═N—, —N═CH—, —NH—CO—, —N═C(NH₂)—, —N═C(SH)—, —NCS—, —NH—O— and —NHNH—, wherein R₅ and R₆ are substituents independently selected from linear alkyl, branched alkyl, cyclic alkyl, and an aromatic ring system, and wherein the alkyl substituents are substituted or unsubstituted. Z is selected from a group of atomic units consisting of —CH═, —N═, and —P═.

13. The display of claim 4, wherein the at least one molecular colorant comprises the following structure: 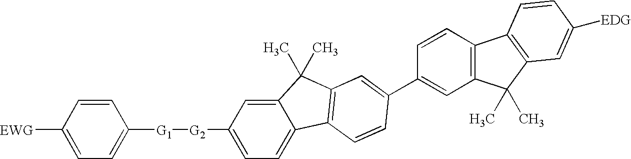
wherein “EWG” is the electron withdrawing group (or acceptor) and is selected from a group consisting of —C(═O)H, —C(═O)R₃, —C(═O)OR₃, —C(═O)OH, —CN, —N═O, —NO₂, —N═N—, CH═NR₃, —CR₃═NR₄, —C═C(CN)₂, —C═C(COR₃)₂, —C═C(CO₂R₃)₂, —C═C(COR₃)CO₂R₄, —SO₂OH, —SO₂OR₃, —S(═O)—R₃, —SO₂R₃, —BH₂, —BHR₃, —BR₃R₄, —PO₃H₂, —PO₃R₃R₄, wherein R₃ and R₄ are substituents independently selected from linear alkyl, branched alkyl, cyclic alkyl, and an aromatic ring system, and wherein the alkyl substituents are substituted or unsubstituted. “EDG” is the electron donating group (or donor) and is selected from a group consisting of —O—, —OH, —OR₁, —NH—, —NH₂, —NHR₁, —NR₁R₂, —PHR₁, —PR₁R₂, —S—, —SH, —SR₁, F, Cl, Br, and I, wherein R₁ and R₂ are substituents independently selected from linear alkyl, branched alkyl, cyclic alkyl, and an aromatic ring system, and wherein the alkyl substituents are substituted or unsubstituted. G₁-G₂ is selected from a group consisting of —CH═CH—, —CH═CR₅—, —CR₅═CR₆—, —CH₂C(═O)—, —CR₅HC(═O)—, —CC—, —N═N—, —N═CH—, —NH—CO—, —N═C(NH₂)—, —N═C(SH)—, —NCS—, —NH—O— and —NHNH—, wherein R₅ and R₆ are substituents independently selected from linear alkyl, branched alkyl, cyclic alkyl, and an aromatic ring system, and wherein the alkyl substituents are substituted or unsubstituted.

14. The display of claim 1, wherein the at least one molecular colorant comprises:
at least one tautomerizable atomic group;
an electron-accepting group;
an electron-donating group; and
at least one conjugating fragment attached to at least one of opposed ends of the at least one tautomerizable atomic group;
wherein either (i) the at least one conjugating fragment is attached to one of the opposed ends of the at least one tautomerizable atomic group and either (a) the electron-donating group is attached to the at least one conjugating fragment and the electron-accepting group is attached to the other of the opposed ends of the at least one tautomerizable atomic group or (b) the electron-accepting group is attached to the at least one conjugating fragment and the electron-donating group is attached to the other of the opposed ends of the at least one tautomerizable atomic group, or (ii) the electron-donating group is attached to a first conjugating fragment that is attached to one of the opposed ends of the at least one tautomerizable atomic group and the electron-accepting group is attached to a second conjugating fragment that is attached to the other of the opposed ends of the at least one tautomerizable atomic group;
and wherein the at least one tautomerizable atomic group is structurally switchable between a conjugation-connected state and a conjugation-disconnected state.

15. The display of claim 14, wherein the electron-donating group is attached to the first conjugating fragment, and the molecule further comprises a tautomerizable atomic group attached between the electron-accepting group and the second conjugating fragment.

16. The display of claim 15, wherein the at least one tautomerizable atomic group comprises a simple tautomerizable atomic groups including at least one of ketones, amides, and combinations thereof, or a dual tautomerizable atomic group (DTAG).

17. The display of claim 15, wherein the DTAG comprises a functionalized nitrogen containing heterocyclic dual-tautomerizable system (FNHDTS) or an ortho-hydroxy dual-tautomerizable system (OHDTS).

18. The display of claim 15, wherein the DTAG comprises a amino-substituted triazine dual-tautomerizable system (ASTDTS), an ortho-pyrrole conjugated imine dual-tautomerizable system (OPCIDTS), or an ortho-imidazole conjugated imine dual-tautomerizable system (OICIDTS).

19. The display of claim 15, wherein the DTAG comprises an ortho-hydroxy conjugated azo dual-tautomerizable system (OHCADTS), an ortho-hydroxy conjugated imine dual-tautomerizable system (OHCIDTS), an ortho-hydroxy conjugated ketone dual-tautomerizable system (OHCKDTS), an ortho-hydroxy azo aromatic dual-tautomerizable system (OHMDTS), an ortho-hydroxy azo heterocyclic dual-tautomerizable system (OHHADTS), an ortho-hydroxy aromatic imine dual-tautomerizable system (OHAIDTS), an ortho-hydroxy heterocyclic imine dual-tautomerizable system (OHHIDTS), an ortho-hydroxy aromatic ketone dual-tautomerizable system (OHAKDTS), or an ortho-hydroxy heterocyclic ketone dual-tautomerizable system (OHHKDTS).

20. The display of claim 14, wherein the molecule is an organic molecule and wherein the at least one tautomerizable atomic group is at least one of an optically switchable molecular functional unit and an electrically switchable molecular functional unit.

21. The display of claim 14, wherein the at least one conjugating fragment comprises —CH═CH—, —CR₁═CR₂—, acetylenes, azo groups, aromatic hydrocarbons, substituted aromatic hydrocarbons, aromatic heterocyclic compounds, biphenyls, bifluorenyls, and mixtures thereof.

22. The display of claim 14, wherein the electron-accepting group comprises at least one of hydrogen; hetero atoms including at least one of N, O, S, P, F, Cl, and Br; functional groups containing at least one of the hetero atoms; saturated hydrocarbons; unsaturated hydrocarbons; substituted hydrocarbons; carboxylic acids; carboxylic esters; amides; nitro groups; nitriles; carbonyls; cyano groups; imines; azo groups; sulfuric acids; sulfuric esters; sulfuric amides; phosphoric acids; phosphoric esters; phosphoric amides; and mixtures thereof.

23. The display of claim 14, wherein the electron-donating group comprises at least one of functional groups containing at least one hetero atom including at least one of B, Si, I, N, O, S, and P; hydrogen; amines; OH; SH; ethers; saturated hydrocarbons; unsaturated hydrocarbons; substituted hydrocarbons; and mixtures thereof, and wherein the electron-donating group is more electropositive than the electron-accepting group.

24. The display of claim 14, wherein the molecule is polarized in the conjugation-connected state, and wherein the molecule is non-polarized in the conjugation-disconnected state.

25. An electronic device comprising:
a device housing; and
an electronically addressable display comprising:
a substrate;
at least one polarization-type, electrical field switchable molecular colorant associated with the substrate;
an addressing device mounted for selectively switching the at least one molecular colorant between at least two visually distinguishable states.
